(19) United States
(12) Patent Application Publication
(10) Pub. No.: US 2024/0242343 A1
(43) Pub. Date: Jul. 18, 2024

(54) Sanitization Analysis and Training Devices, Systems, and Methods

(71) Applicant: HyGenius, Inc., Davis, CA (US)

(72) Inventor: Sam Michael Skinner, Davis, CA (US)

(73) Assignee: HyGenius, Inc., Davis, CA (US)

(21) Appl. No.: 18/442,087

(22) Filed: Feb. 14, 2024

Related U.S. Application Data
(63) Continuation-in-part of application No. 17/402,464, filed on Aug. 13, 2021.
(60) Provisional application No. 63/485,453, filed on Feb. 16, 2023.
(60) Provisional application No. 63/065,764, filed on Aug. 14, 2020.

(51) Int. Cl. G06T 7/00; G06V 10/26; G06V 10/764; G06V 20/52; G06V 40/10; G06V 40/20; G09B 5/02; H04N 23/23; H04N 23/74

(52) U.S. Cl. CPC G06T 7/0012; G06V 10/26; G06V 10/764; G06V 20/52; G06V 40/107; G06V 40/28; G09B 5/02; H04N 23/23; H04N 23/74; G06T 2207/10048; G06T 2207/10064; G06T 2207/30196; G06T 2207/30232

(57) ABSTRACT

Systems, devices, methods, and software for sanitization monitoring of hands, other body parts, and objects and training users on sanitization methods. The systems and devices including a detector to provide images of the object within its detection range, and at least one processor to receive the images from the detector, determine areas of the image corresponding to sanitized areas of the object from unsanitized areas of the object, calculate a percentage of sanitized areas to the total area corresponding to the sanitized and unsanitized areas, and report at least the percentage of sanitized area and/or compare a user's sanitization techniques to approved sanitization techniques and provide guidance to user. In various embodiments, users sanitize their hands with fluorescing hand sanitizer and/or a fluorescing germ-proxy agent with soap and water and the sanitized and unsanitized areas are determined based on the amount of fluorescing material remaining on the hands after application.

### CROSS-REFERENCE TO RELATED APPLICATIONS

This application claims priority to and the benefit of U.S. Provisional Patent Application No. 63/485,453 filed on Feb. 16, 2023 and is a continuation-in-part of U.S. patent application Ser. No. 17/402,464 filed on Aug. 13, 2021, and PCT Application No. PCT/US21/46039 filed on Aug. 13, 2021, both of which claim priority to and the benefit of U.S. Provisional Patent Application No. 63/065,764 filed on Aug. 14, 2020, the disclosure of each is incorporated by reference in its entireties.

### STATEMENT REGARDING FEDERALLY SPONSORED RESEARCH OR DEVELOPMENT

Not Applicable

### BACKGROUND OF THE INVENTION

### Field of the Invention

The present invention generally relates to analyzing cleanliness/sanitization of body parts and other objects. More specifically, the invention relates to sanitization monitoring and analysis devices, systems, and methods for analyzing the sanitization of hands and other objects to support sanitized procedures in the life sciences, e.g., medicine, and other areas of life where sanitization is of importance.

### Background Art

1 in 25 hospitalized patients in the US are affected by a healthcare-associated infection (HAI) acquired during their stay in a medical facility as a result of poor infection prevention efforts, which cause up to $31 billion in medical costs each year in treatment in the US alone according to “Healthcare-Associated Infections.” Healthy People, 2020, http://www.healthypeople.gov/2020/topics-objectives/topic/healthcare-associated-infections. The number one cause of HAI is poor hand hygiene, which directly accounts for at least 40%, and up to even 70% of all HAIs according to “Hand Hygiene Compliance and Associated Factors among Health Care Providers in Central Gondar Zone Public Primary Hospitals, Northwest Ethiopia.”, Engdaw, Garedew Tadege, et al., Antimicrobial Resistance & Infection Control, vol. 8, No. 1, 2019, doi: 10.1186/s13756-019-0634-z., and Pyrek, Kelly M., Infection Control Today, Informa Exhibitions LLC, 2014, The Economics of Hand Hygiene Compliance Monitoring, respectively.

Hand sanitization with a sanitizer solution and hand washing with soap & water are the best ways to keep one's hands clean and kill or reduce bacteria and viruses on hands. Hand sanitizer manufacturers claim that their products can kill 99.9% of germs, with studies showing that proper hand sanitizer application can eliminate nearly all pathogens on one's hands (Sutter, S. Tschudin, et al. “Effect of Teaching Recommended World Health Organization Technique on the Use of Alcohol-Based Hand Rub by Medical Students.” Infection Control & Hospital Epidemiology, vol. 31, No. 11, 2010, pp. 1194-1195, doi: 10.1086/656745. https://edoc.unibas.ch/23422/1/effect_of_teaching_recommended_world_health_organization_technique_on_the_use_of_alcoholbased_hand_rub_by_medical_students.pdf), or at least most of them (over 80%, per Chow, Angela, et al. “Alcohol Handrubbing and Chlorhexidine Handwashing Protocols for Routine Hospital Practice: A Randomized Clinical Trial of Protocol Efficacy and Time Effectiveness.” American Journal of Infection Control, vol. 40, No. 9, 2012, pp. 800-805., doi: 10.1016/j.ajic.2011.10.005. https://www.sciencedirect.com/science/article/pii/S0196655311012594, and Girou, E., “Efficacy of Handrubbing with Alcohol Based Solution versus Standard Handwashing with Antiseptic Soap: Randomised Clinical Trial.”, Bmj, vol. 325, No. 7360, 2002, pp. 362-362, doi: 10.1136/bmj.325.7360.362. https://www.ncbi.nlm.nih.gov/pmc/articles/PMC117885/).

Hand washing also reduces pathogens on hands to a high degree, with 15 seconds of proper washing reducing about 90% of pathogens, and 30 seconds up to 99.9% (Harvard Health Publishing, The Handiwork of Good Health, www.health.harvard.edu/newsletter_article/The_handiwork_of_good_health.). However, oftentimes this high reduction factor of pathogens is not the case.

Hand sanitizer and soap & water are just tools people can use to reduce germ levels, but the effectiveness of those tools depends on how well the tools are used. Unfortunately, not very many people apply hand sanitizer and/or wash their hands properly and effectively.

There are two main barriers to effective use of hand sanitizer and soap & water. The first is called the “Hawthorne Effect”, something even Healthcare Workers (HCWs) fall prey to, whereby people change their behavior depending on whether or not they know they're being monitored. Investigators found HCWs only complied with hand hygiene protocols, i.e., only sanitized or washed their hands after medical center guidelines said they should, only 22% of the time when they didn't think they were being observed (Barzilay, Julie. “Doctors' Hand Hygiene Plummets Unless They Know They're Being Watched, Study Finds.” ABC News, ABC News Network, 9 Jun. 2016, https://abcnews.go.com/Health/doctors-hand-hygiene-plummets-watched-study-finds/story?id=39737505).

The second barrier is the lack of training on and reliable/consistent use of proper hand cleaning techniques. For both hand sanitization and hand washing, the World Health Organization (“WHO”) has laid out a 6-step protocol that cleans all parts of an individual's hands through tactical hand rub techniques. See Widmer, Andreas F., et al. “Introducing Alcohol-Based Hand Rub for Hand Hygiene The Critical Need for Training.” Infection Control & Hospital Epidemiology, vol. 28, No. 1, 2007, pp. 50-54., doi: 10.1086/510788. https://www.researchgate.net/profile/Reno_Frei/publication/6573072_Introducing_Alcohol-Based_Hand_Rub_for_Hand_Hygiene_The_Critical_Need_for_Training/links/00463514c7b95a8561000000/Introducing-Alcohol-Based-Hand-Rub-for-Hand-Hygiene-The-Critical-Need-for-Training.pdf, which is incorporated herein by reference However, one study showed that again, even among highly trained and very health-conscious healthcare workers, only 31% used proper technique, which correlated to the hand cleaning efforts only being about 66% as effective as they would have been had proper technique been used. This is due to the fact that proper use of such techniques has been proven to increase the microbial reduction factor of hand cleaning by 50% compared to non-use.

Thus, in a very real way, proper use of hand sanitizer and soap & water is very important to public health. As such, there is a continuing need for sanitization methods, solutions, and devices that improve the proper use of hand sanitizer and soap & water and other hygiene methods.

### BRIEF SUMMARY OF THE INVENTION

The present invention addresses the above noted needs by providing stationary or portable sanitizing monitoring devices, systems and methods that may be employed in a stand-alone manner or with existing sanitizing devices, such as hand sanitizer stations, sinks, etc. to provide real time feedback to the person performing the sanitization of hands, other body parts, other devices, etc., and data for improvement. Systems, devices, methods, and software of the present invention provide for sanitization monitoring of hands, other body parts, and object. The systems and devices including a detector to provide images of the object within its detection range, and at least one processor to receive the images from the detector, determine areas of the image corresponding to sanitized areas of the object from unsanitized areas of the object, calculate a percentage of sanitized areas to the total area corresponding to the sanitized and unsanitized areas, and report at least the percentage of sanitized area. In various embodiments, the sanitizing monitoring device analyzes and quantifies the thoroughness of the sanitization into a score as the sanitization is performed and/or afterward, and provide feedback in the form of suggestions for improvement and areas where additional sanitization may be required.

In various embodiments, the system may include a chamber with a black interior with UV LED lights positioned the inside of the chamber to illuminate a hand detection area in the chamber. The detector may be positioned to detect hands placed in the hand detection area, which may be implemented as visible light camera suitable for capturing images and streaming video images. The system may include or be associated with a computer for receiving and processing the image data from the detector and determining areas of the image corresponding to sanitized areas of the hands from unsanitized areas of the hands based on the fluorescence of the hands, calculating a score using at least a percentage of the sanitized areas to a total area corresponding to the sanitized plus the unsanitized areas, and providing at least the score to a display positioned proximate the chamber to display at least the score. Additional information about how to improve handwashing scores may also be provided to the user.

In various other embodiments, an illumination device may or may not be employed when the detector includes a thermal imaging camera that may be used alone or with a visible light camera to provide thermal images of the hands or other objects. In thermal imaging camera embodiments, sanitization may be performed in the hand detection area using alcohol-based hand sanitizer and the thermal imaging camera is used to detect surface temperature differences induced by the hand sanitizer to determine the sanitized and unsanitized areas of the hands or object.

In various embodiments, the system may include a hand sanitizer dispenser containing fluorescing hand sanitizer and/or a fluorescing germ-proxy agent and soap dispenser positioned proximate the chamber. The computer, via one or more processors, may provide instructions on using the system to sanitize their hands with the fluorescing hand sanitizer and a fluorescing germ-proxy agent with soap to the display for viewing and suggestions for improvement. The software running on the computer may also detect one or more hand rubbing techniques, as well as the duration of hand rubbing from the images, which may also be used to calculate the score.

The system may identify a user of the system based on information from an identification device, such as an RFID device, information that may be manually input into the display by the user, and an identifier received via a wireless signal. The processor would then store information derived from the sanitization process, such as the scores, the percentage of sanitized area, the detected hand rubbing techniques, the duration of hand rubbing, the number of times sanitization was attempted, etc. and provide some or all of the information to the user via the display and/or to interested parties and management systems for storage that are remote from the system.

The system via the software and processors may compare the sanitization process information against other users and/or various groups of users and provide the comparison of information to the display for viewing. The system may also request, via the display, the user to further sanitize their hands when the score does not exceed a threshold score. When the process is complete, the system may associate the information with the user and store the information associated with the user locally in the computer and/or remote in a database that may be associated with a management system.

In various embodiments, the system may include a water faucet to dispense water proximate the hand detection area to support the washing of hands and other objects in the hand detection area of the system.

The system and software of the present invention may implement various methods of hand sanitization monitoring by providing a chamber or a kiosk (which may or may not be adjustable in height) with at least one illumination device positioned within the chamber or kiosk to illuminate a hand detection area and a detector positioned to detect and provide images of hands within the hand detection area. A user may sanitize their hands with at least one of a fluorescing hand sanitizer and a fluorescing germ-proxy agent with soap and perform the sanitization in the hand detection area, while the detection area is illuminated by the at least one illumination device; such as a UV light and the detector, such as a visual camera, may be detecting and providing images of the hands to a processor in the computer. The processor may analyze the images and determine areas of the image corresponding to sanitized areas and unsanitized areas of the hands, then calculate a percentage score using the total sanitized area divided by the total area corresponding to the total sanitized plus total unsanitized areas, and provide the score and/or percentage of sanitized area to the display and/or the management system.

For embodiments in which the hand sanitization is performed in the hand detection area, the software and system may detect various hand rubbing techniques and the duration of hand rubbing from the images and use that information in the calculation of the score, as well as report the information to the user along with information about how the user can improve their sanitization score. In various embodiments, the scores of various users may be compared and displayed to incentivize improve sanitization habits.

Accordingly, the present disclosure addresses the continuing need for improved methods and system for sanitizing hands and other objects and methods for documenting and continually improve hygiene.

### BRIEF DESCRIPTION OF THE DRAWINGS

The accompanying drawings are included for the purpose of exemplary illustration of various aspects and embodiments of the present invention, and not for purposes of limiting the invention, wherein:

The present invention is illustrated by way of example and not limitation in the figures of the accompanying drawings in which like references indicate similar elements.

FIG. 1 illustrates an angled view of the front right side of exemplary embodiments of the system.

FIG. 2 illustrates an angled view of the front left side of exemplary embodiments of the system.

FIG. 3 illustrates a view that shows the front, left, and underside of exemplary embodiments of the system.

FIG. 4 illustrates a top view of exemplary embodiments of the system.

FIG. 5 illustrates a bottom view of exemplary embodiments of the system.

FIG. 6 illustrates a front view of exemplary embodiments of the system.

FIG. 7 illustrates a back view of exemplary embodiments of the system.

FIG. 8 illustrates a view of the left side of exemplary embodiments of the system.

FIG. 9 illustrates a view of the right side of exemplary embodiments of the system.

FIG. 10 illustrates a view of the top, back, and right sides of exemplary embodiments of the system.

FIG. 11 illustrates a view of the top, front, and right sides of exemplary embodiments of the system.

FIG. 12 illustrates a view of the top, back, and right sides of exemplary embodiments of the system.

FIG. 13 illustrates a front view of other exemplary embodiments of the system.

FIG. 14 illustrates a top, right, front view of other exemplary embodiments of the system.

FIG. 15 illustrates a bottom side view of other exemplary embodiments of the system.

FIG. 16 illustrates a top, left, back view of other exemplary embodiments of the system.

FIG. 17 illustrates a back view of other exemplary embodiments of the system.

FIG. 18 illustrates a back view of other exemplary embodiments of the system.

FIG. 19 shows exemplary ecosystems in which the system may be employed.

FIG. 20 depicts exemplary component process flows that may be employed in the system.

FIGS. 21 and 22 provide exemplary software process flows.

FIGS. 23-34 show exemplary displays and techniques involved in the sanitization monitoring and analysis process.

FIG. 35 illustrates exemplary component embodiments of various computing resources that may be used in the present invention.

FIG. 36 depicts exemplary frontal views of portable open-space kiosk embodiments.

FIG. 37 depicts an exemplary front top perspective view of the FIG. 36 embodiments.

FIG. 38 depicts a right side view of the embodiments of the system depicted in FIGS. 36-37.

FIG. 39 depicts a back view of the top portion of the embodiments of the system depicted in FIGS. 36-38.

FIG. 40 depicts a back right perspective view of the top portion of the embodiments of the system depicted in FIGS. 36-39.

FIGS. 41-43 depict a front left bottom perspective view of the top portion of the embodiments of the system depicted in FIGS. 36-40.

FIGS. 44-46 provides exemplary software process flow for the system.

FIG. 47 depicts exemplary front right top views of embodiments of the system with a height-adjustable portable kiosk, a lighting system attached to a height-adjustable column and an adjustable workspace surface under the hood

FIG. 48 depicts an exemplary back right perspective view of embodiments of the systems such as those depicted in FIG. 47

FIG. 49 depicts an exemplary front left bottom view of the top portion of the embodiments of the system such as those depicted in FIGS. 47-48

FIG. 50 depicts an exemplary front left top view of the top portion of the embodiments of the system such as those depicted in FIGS. 47-49

FIG. 51 depicts an exemplary front right top views of the top portion of an embodiment of the system such as those depicted in FIGS. 47-49 that uses thermal optical devices in the hood instead of an LED PCB

FIG. 52 depicts an exemplary right side view of the embodiment of the system such as those depicted in FIG. 51

FIG. 53 depicts an exemplary bottom view of the underside of the hood of the embodiment of the system such as those depicted in FIG. 52, with two thermal optical devices

FIGS. 54-55 depict an exemplary bottom view of the underside of the hood of the embodiment of the system such as those depicted in FIGS. 51-53, with one thermal optical device

FIG. 56 depicts an exemplary front right top view of the inside of the hood of the embodiment of the system such as those depicted in FIGS. 51-55

FIG. 57 depicts exemplary software process flows for the embodiment of the system such as those depicted in FIGS. 51-56

In the drawings and detailed description, the same or similar reference numbers may identify the same or similar elements. It will be appreciated that the implementations, features, etc. described with respect to embodiments in specific figures may be implemented with respect to other embodiments in other figures, unless expressly stated, or otherwise not possible.

### DETAILED DESCRIPTION OF THE INVENTION

Systems 15 of the present invention provide for sanitization monitoring and may include cleaning of hands, other body parts, objects, etc. The system 15 may include various components that may be integrated as a stand-alone device 17 or separately interoperating to provide the desired functionality.

To ease the description of the invention, the present invention will be described in terms of sanitization, which should be interpreted in the context of the present invention and application to mean cleaning, sanitization, disinfection, sterilization, and other similar terms pertaining to processes and procedures for removing and/or killing microorganism and non-living matter present on a surface, unless otherwise stated. To further ease the description of the invention, the system 15 and its various features, embodiments, etc. will be described with respect to sanitizing and monitoring and determining the sanitization/cleanliness of hands. However, it will be appreciated that the invention may also be more generally applicable to sanitization monitoring of other body parts, objects, etc. with appropriate modification to the dimensions and components of the system, unless otherwise stated.

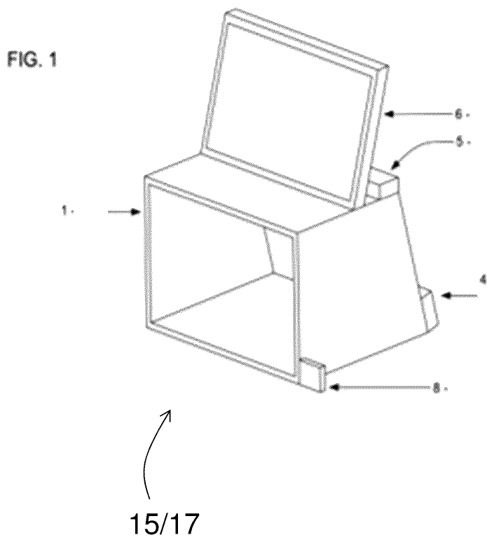

FIG. 1 depicts exemplary embodiments of system 15 as shown from a front, right, and top view. The system 15 may include a chamber 1 that may be any shape or design conducive to enable hands, other body parts, or workpieces and objects to be examined within the chamber 1. For example, the chamber 1 may be a rectangular prism in shape with a slanted back wall, with the entire front as an opening for a user to insert both hands and possibly perform sanitization activities within the chamber.

The interior of the chamber 1 may be a dark, non-reflective color, such as black, but may not be limited to such a specific color or lighting. The use of the chamber 1, while not required in many embodiments, provides a consistent environment for hand detection and the elimination of the background from the analysis.

A power source 4 may be provided in the form one or more batteries deployed on or in proximity to the chamber 1. Other embodiments of the power source 4 may include a power cable connected to the device and draws power from a wall outlet or other electricity source, in addition to, or in lieu, of the batteries.

The system 15 may include a computer 5, which may be integrated into or attached to the inside or outside wall of the chamber 1 or separate from the chamber 1. FIG. 1 depicts the computer 5 mounted to the top outside wall of the chamber 1. The computer 5 may be a single board computer that may include memory and storage that may be self-contained or interoperate with a remote server and/or management system.

A display 6 may be provided proximate to the chamber to provide feedback and information to the users and/or others. The display may be a monitor, television, etc. and may include analog display, red/yellow/green lights, etc. FIG. 1 shows the display on the outside top of the chamber 1, but the display may be provided separately from the chamber 1. For example, the computer 5 and display 6 may be embodied as a desktop, laptop, tablet, phone, etc. that is deployed on or proximate the chamber 1 if it is desired to have the display 6 visible to the user. In other embodiments, the display may not be visible to the user or disabled, such as during testing to determine the baseline and/or periodic levels of sanitization.

In various embodiments, a user identification device 8 may be employed in the system 15 to identify the person using the system 15. For example, a Near Field Communications/Radio Frequency Identification (NFC/RFID) reader may be used to transfer data between user badges/devices and the system 15. In other embodiments, a camera may be used for visual identification, or a scanner for barcode/QR identification. In FIG. 1 embodiments, the id reader 8 is shown attached to the bottom front right corner of the chamber 1, but may be deployed in any location suitable on or separate from the chamber 1 for its purpose.

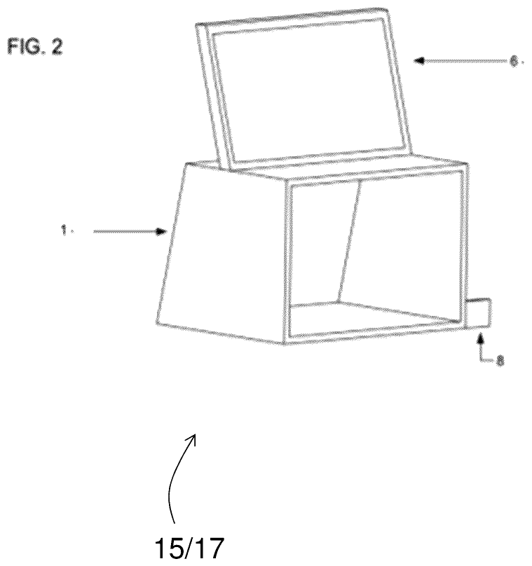

FIG. 2 shows another rotated view of the FIG. 1 embodiments showing the front, left, and top of the chamber 1 and exemplary location of the display 6 and id device 8.

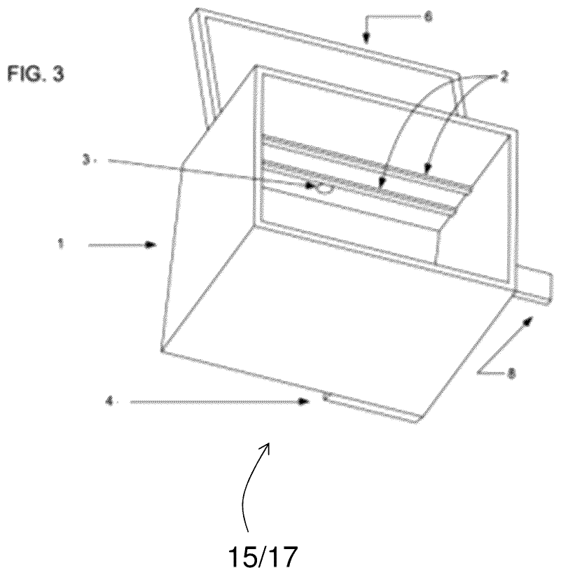

FIG. 3 illustrates various embodiments of the system 15, such as those in FIGS. 1-2, from a bottom left perspective of the chamber 1. This perspective depicts the outside bottom and left walls of the chamber 1, as well as its interior, and exemplary locations for the power source 4, display 6, and id device 8.

In various embodiments, one or more illumination devices, e.g., UV lights, 2 and a detector 3, such as a camera, may be provided inside the chamber 1, such as fitted to the inside top surface of the chamber 1 to visually detect a sanitization indicator. While UV LEDs are good for power efficiency and brightness, other embodiments of the system 15 may employ other types of UV lights or other types of illumination devices 2. In addition, more or less lights than shown in the figures may be employed. The illumination device may emit light in the UV A range, e.g., 395-405 nm, and at safe intensity levels.

The detector 3 may be a visual light camera, a thermal camera, or other appropriate detector suitably matched to detect an indicator being used in various embodiments. In FIG. 3 embodiments, the detector 3 may be located proximate the UV LED lights, such as near the back of the chamber's ceiling, though other embodiments may have it placed elsewhere.

In various embodiments employing a thermal sensor as the detector 3, the system 15 may not include a chamber 1 or lights 2. In these embodiments, the user may be instructed 1) to position their hands, object, etc. being sanitized proximate to the detector 3, so the detector 3 can detect a pre-clean thermal pattern, 2) apply hand sanitizer or other cleaner and clean their hands, objects, etc., and 3) place their hands, objects, etc. The system 15 then compares the pre-clean and post-clean images to determine the sanitization level. Some embodiments may not use a pre-clean image to determine sanitization level, which may be determined from the post-cleaning step alone.

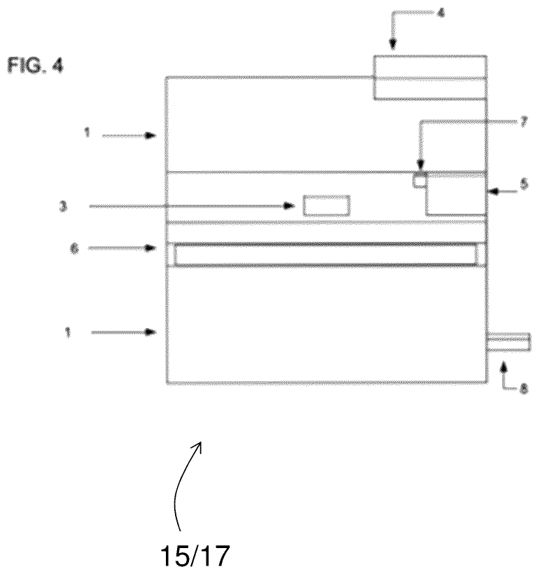

FIG. 4 illustrates a top view of embodiments corresponding to FIGS. 1-3, with the system 15 front facing down and back facing up. FIG. 4 further depicts a wireless receiver/transceiver 7, such as a Bluetooth transceiver in communication with the computer 5 to enable wireless communications between the computer 5 and one or more of the detector 3, id device 8, lights 3, display 6, and a remote management system. The wireless receiver 7 may also be an alternative to the id device 8.

FIG. 4 shows the detector 3 integrated into the back of the top wall of the chamber 1 behind the display 6 and to the left of the computer 5. However, as with component, the detector 3 may have it placed elsewhere on the chamber 1.

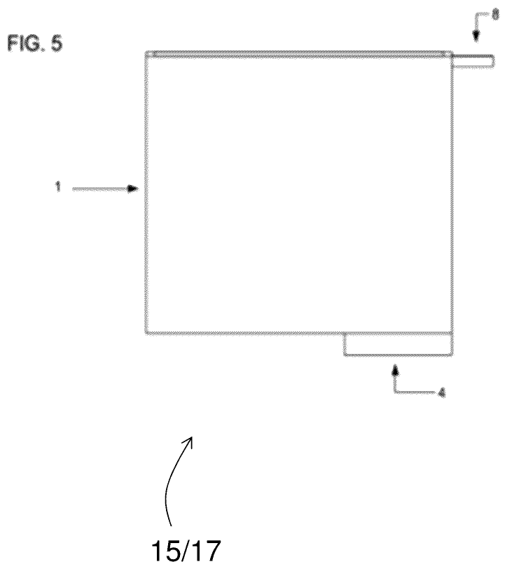

FIG. 5 illustrates a bottom view of the embodiments shown in FIGS. 1-4. In various other embodiments, it may be desirable to not include a bottom on the chamber 1. However, the bottom of the chamber 1 may provide a consistent background for the detector 3 in the hand detection area, which may enable the software to make consistently subtract/remove the bottom/background from images of the hands. In other embodiments not involving a chamber 1, it may also be desirable to provide a consistent background for the detector 3.

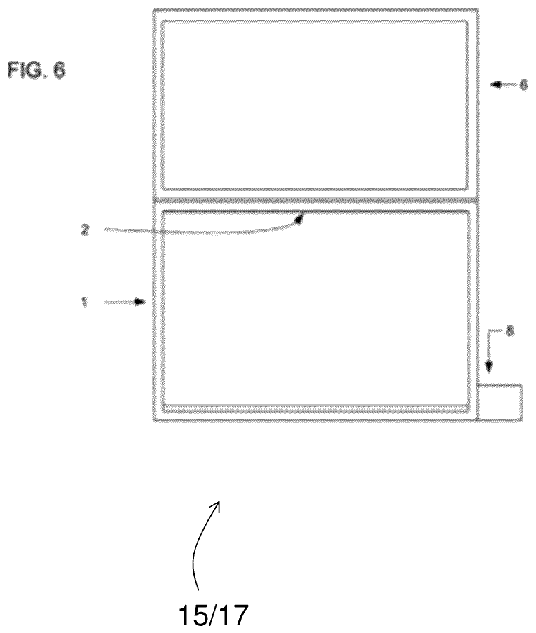

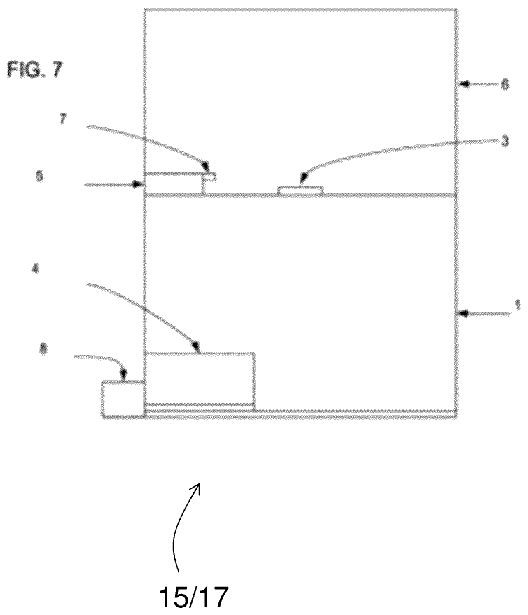

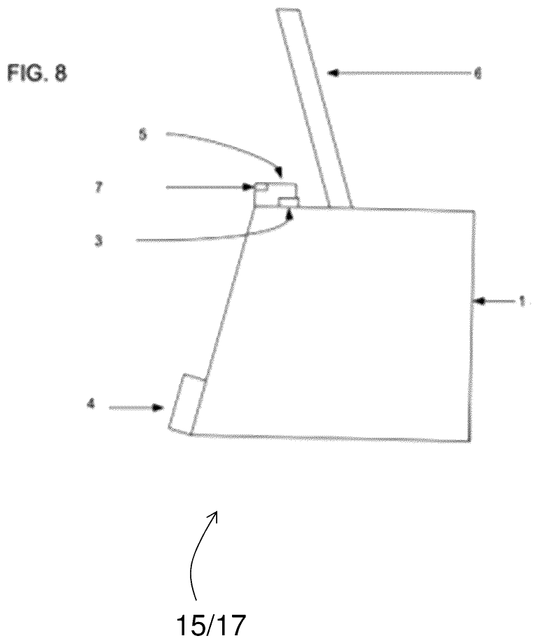

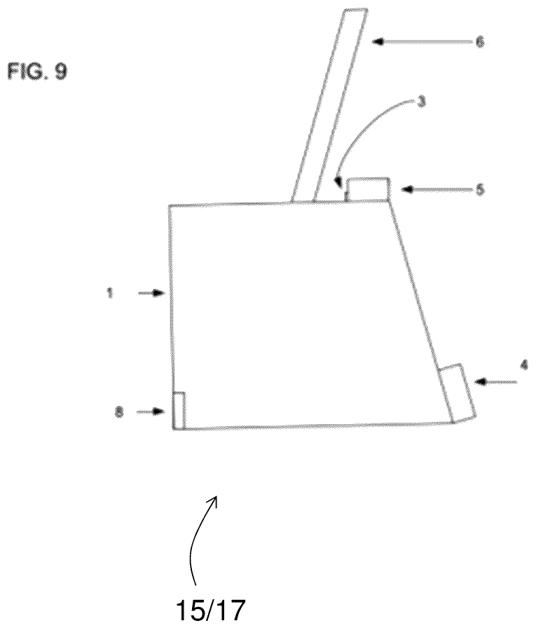

FIGS. 6-9 respectively show front, back, left, and right side view of the embodiments shown as perspective views in FIGS. 1-5. Of note, in FIGS. 8 and 9 are the angles/slants of the chamber 1 back wall and the display 6. The back wall of the chamber 1 is slanted back from top to bottom in this embodiment to be out of view of the detector, as well as provide users with extra room within the chamber 1 to clean their hands, etc., though other embodiments may have this slant be different or nonexistent.

The display 6 is slanted back from bottom to top in this embodiment in order to provide a better viewing angle for the user, though other embodiments may have this slant be different or nonexistent. Supporting pillars/walls as well as attachments at the base into the top wall of the chamber 1 are not shown in order to view the important components of the system 15 more easily.

FIG. 10 is a perspective view of the embodiments of FIGS. 1-9 from the top, back, right side. This illustration's view is important as it shows the 3 walls of the chamber (1) on which all of the external components (1,3-8) are placed, and their relative positions, as well as the slants of the back wall of the chamber and the display screen (6). The only components that cannot be seen are on the inside of the chamber integrated into its ceiling, namely the UV LED lights (2) and the underside/front of the optical device (3).

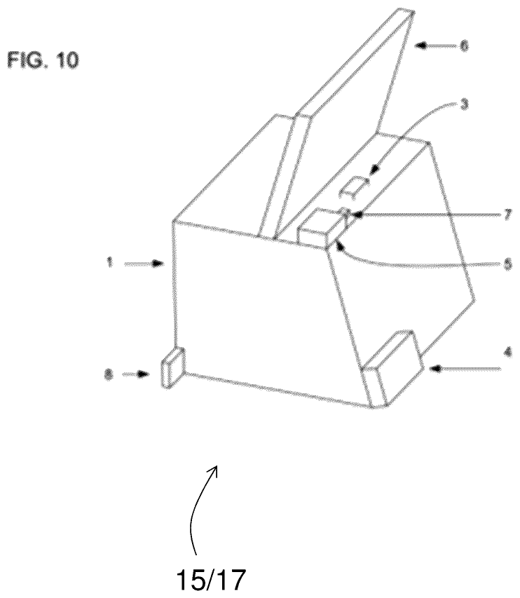

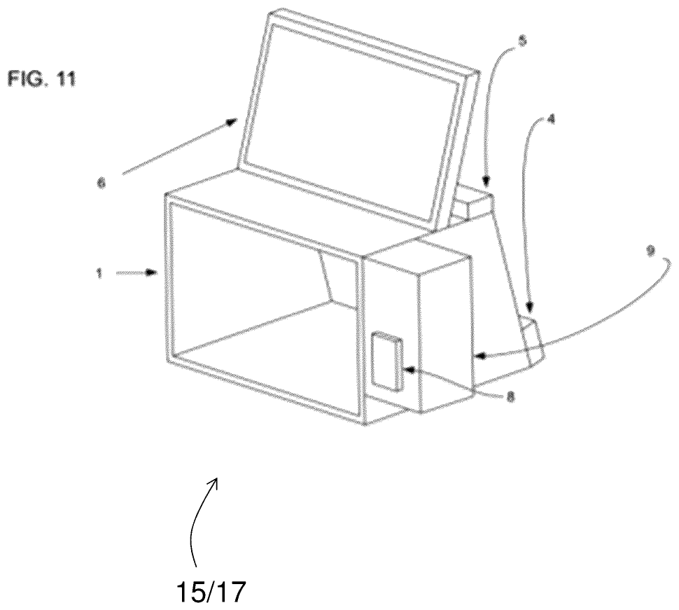

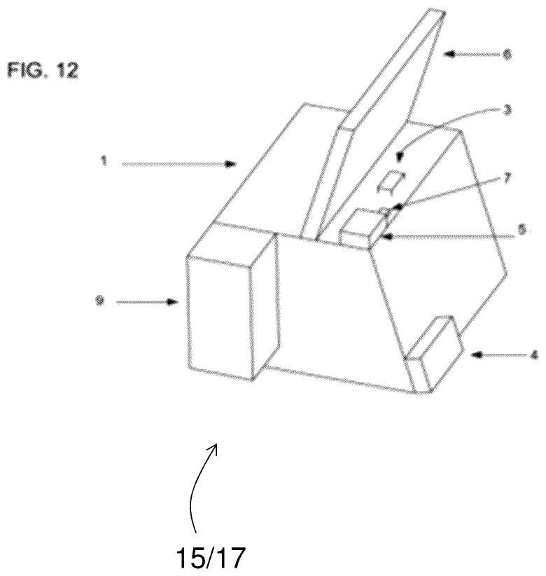

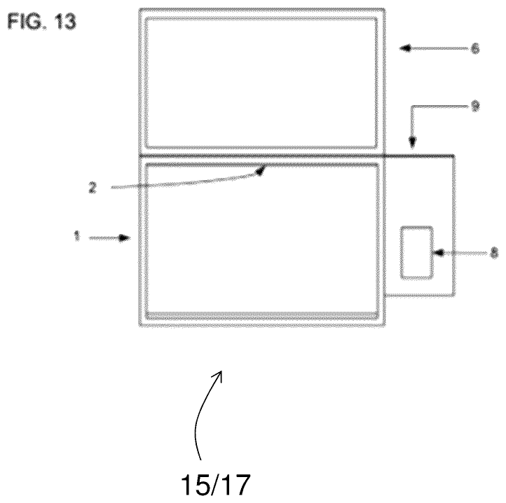

FIGS. 11-13 depict embodiments of the system 15 similar to FIGS. 1-10, but further includes a hand sanitizer dispenser 9 attached to the chamber 1. In these embodiments, the dispenser 9 is shown as attached to the right wall of the chamber 1, but may be positioned in other locations on the chamber 1. The dispenser 9 may be a manual or automatic, but it may be more desirable to employ an automatic dispenser 9 to minimize contact with the dispenser 9. The embodiments depicted in FIG. 11-13 also show the id device 8 positioned on the dispenser 9, but if may be located elsewhere on the chamber 1 or not on the chamber.

FIGS. 14-18 depict embodiments of the system 15 similar to the embodiments shown in FIGS. 1-10, but including an automatic sink faucet 11, an automatic fluorescing agent (germ-proxy) dispenser 12 connected to the right wall of the chamber 1, and an automatic soap dispenser 13. The id device 8 may be connected to the front of the automatic hand fluorescing agent dispenser 12, but may be positioned in other locations on the chamber 1 or separate from the chamber 1.

The dispensers 12 and 13 may positioned on opposite sides of the chamber 1 or be separate, such as may be in FIGS. 1-10. The dispensers may be automatic and shaped like rectangular prisms that dispense from the bottom, automatic dispensers shaped like cylinders that dispense from the top, or may be the kind that siphon the fluids from a tub hidden underneath a sink counter connected by a thin & long hose/tube, or something else entirely. In this embodiment the sink faucet and dispensers are as described, though other embodiments may have them shaped, placed, and oriented otherwise.

FIG. 15 is a bottom left front view showing a sink faucet integrated, showing a faucet spout 11 running along the ceiling of the wall of the chamber 1 and the faucet pipe end at the back bottom of the chamber 1, but the faucet 11 and plumbing may be placed elsewhere in the chamber 1. The detector 3 may be repositioned in these embodiments for a couple of reasons. One is to allow the detector 3 to be attached or embedded within the faucet 11 without impeding the flow of water to the opening of the faucet 11. The second and more important reason (hence why the detector 3 is not just placed underneath the faucet spout 11 but behind the opening) is that the sink is automatic, and should not always be running when one is using the hand rub techniques when washing their hands, and scanning their hands after completing their hand cleaning event. The detector 3 being in front of the faucet opening and motion sensor 10 allows one to have their hand cleaning and hand scanning monitored without activating the flow of water all the time. In this embodiment the sink faucet 11 and integrated components are as described, though other embodiments may have them shaped, placed, and oriented otherwise.

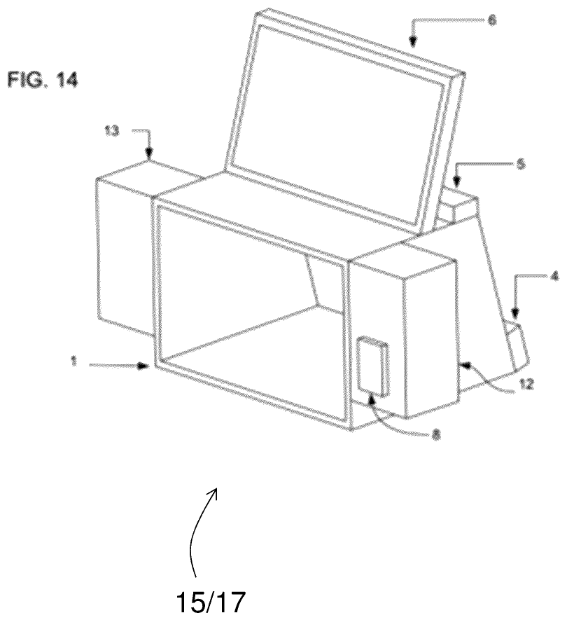

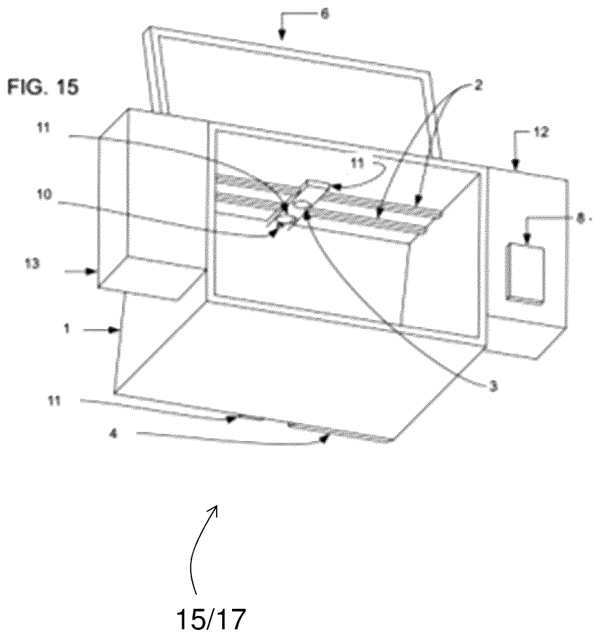

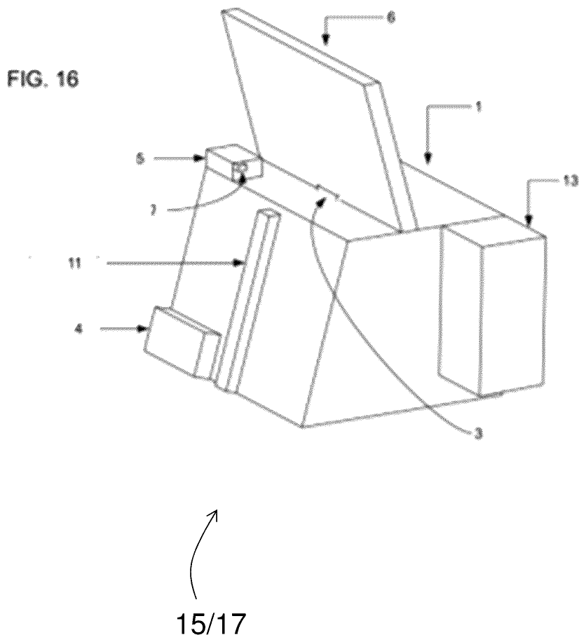

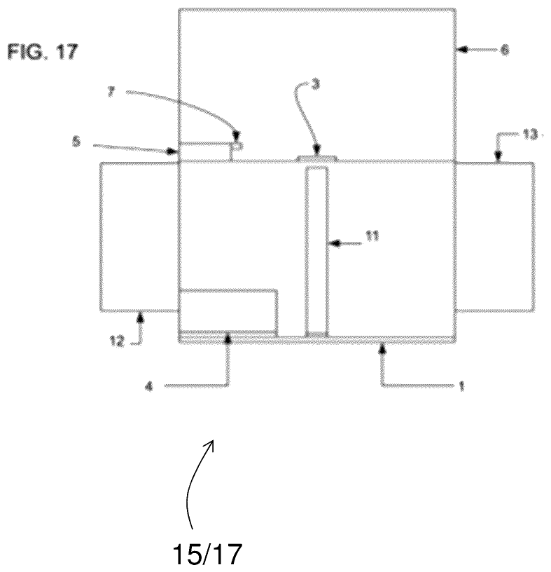

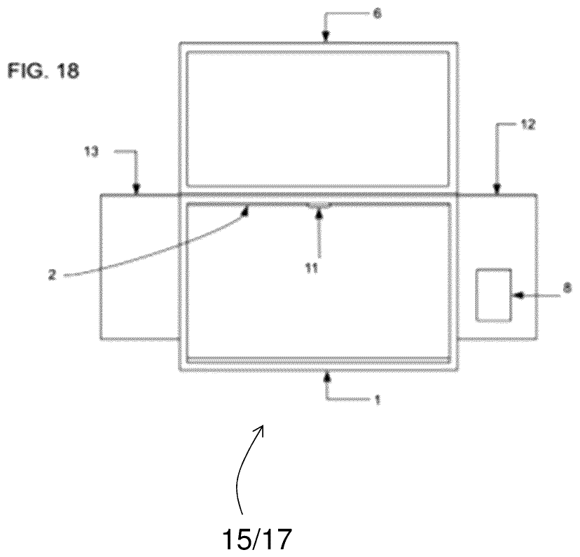

FIG. 16-17 shows a rotated back, left, and top view and back view. In this view, the faucet 11 pipe is shown running down the back wall of the chamber 1. FIG. 18 provides a front view showing the faucet 11, fluorescing agent dispenser 12, and soap dispenser 13.

Overall, the present invention may include various processes that leverage some or all of the components and functionality described to provide various measure of the effectiveness of the sanitization process.

For example, in various embodiments, the system 15 may be provided with power from the power source 4, so the system 15 may be in standby mode and ready for use when activated. A user may activate the system 15 by placing an ID in proximate with the id device 8, by establishing a connection with the wireless device 7, and/or manually by actuating a switch or motion sensor on the system 15.

The system 15 may access, or prompt the user to provide, a user profile that may be stored in the computer 5 and/or a database that may be remote from the computer 5. The system 15 may display information about the user on the display 6, so the user may confirm their identity is correct.

For hand sanitizer application, the next step may involve dispensing the hand sanitizer. The dispenser 9 may be included in the system 15 or may be separate from the system 15. Prior to dispensing the sanitizer, the user may place their hands or the object to be sanitized under the detector 3 so a baseline measurement can be performed. The user then dispenses hand sanitizer onto their hands, rubs in the sanitizer, and places their hands back under the detector 3, so additional measurements can be performed. If the user rubs in the sanitizer under the detector 3, the system 15 may provide real-time updates on the progress of the sanitization.

Sanitization monitoring for hand sanitizers may be provided with the detector 3 being implemented as a camera for detecting a visible indicator and/or a thermal detector for thermal detection, such as changes in the skin temperature due to contact with evaporating hand sanitizers, e.g., alcohol based.

For visual detection using a camera as the detector, the hand sanitizer or soap employed may include, or be used with, a fluorescing substance that fluoresces at the wavelength emitted by the illumination devices 2, e.g., UV-A. For example, the hand sanitizer or soap may include, or be used with, Fluorescein, FD&C Yellow No. 7, which is an FDA approved non-toxic fluorescing dye.

Commercial off the shelf soaps may also be employed in the present invention and used with a fluorescing germ-proxy agent, such as are commercially available under the names Glo-Germ, https://www.glogerm.com/, GlitterBug Potion, https://www.brevis.com/glitterbug, Wash & Glow, and Glow Specialist.

For the embodiments involving soap and water, the user may first dispense the fluorescing germ-proxy agent, if separate, and rub the agent into their hands thoroughly, then dispense soap and rub the soap into their hands thoroughly before rinsing the soap and agent from their hands. In some embodiments, the users may scan their hands, front and back, with the detector 3 after rubbing in the fluorescing germ-proxy agent and before dispensing the soap onto their hands to make sure the fluorescing germ-proxy agent thoroughly covers their hands.

When the user places their hands in the view of the detector 3, which captures images of the user's hands at various stages of the cleaning process, the various images are then compared to assess the effectiveness of the sanitization process. For example, at each stage the user may be instructed to place their hands in certain positions to facilitate the imaging and image comparison process. Videos of the sanitizer application or hand washing, and images of the fluorescing sanitizer's coverage post-application or fluorescing germ-proxy's removal when the user displays their hands flat above the floor of the chamber 1, showing the tops and bottoms, one after the other made be stored and displayed to user. Images may be analyzed by software run in the computer 5, which can both track the user's hand movements to determine how they applied the sanitizers or removed the germ-proxy, and identify hand sanitizing techniques used (which may be those specified by the WHO's or other hand rubbing protocols), as well as determine the absolute level of coverage of the fluorescing sanitizer on the hands or absolute level of removal of the fluorescing germ-proxy.

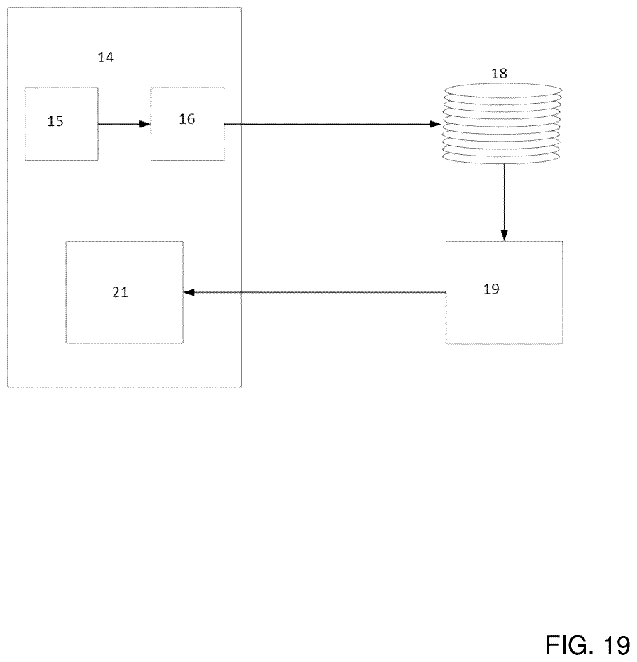

FIG. 19 shows an Ecosystem Map schematic of the system 15 as part of an exemplary ecosystem within which various embodiments may operate. A facility 14 may house the system 15, which in turn, may host some or all of software 16 used by the system 15 to monitor the sanitization process. The software 16 may collect and process information, i.e., raw data and calculated data, from each use of the system 15 and send the information to a database 18, which may be in the cloud, stored locally at the facility 14, and/or hosted elsewhere and may be part of a management system. The information stored in the database 18 maythen be accessed by one or more software applications 19 in the cloud, at the facility 14, on the system 15, or elsewhere, which may process the information to make it more understandable, useful, and actionable. This processed data may then be sent to, or accessed by each various facility and/or management platforms 21, whereby users, facility staff (which in the case of healthcare centers may be, but are not limited to, Directors of Nursing, Directors of Epidemiology, Infection Preventionists, Chief Quality Officers, etc.), and other interested parties may access metrics and reports that inform them on the hand sanitization performance and trends of the users, both individually and in the aggregate.

The various components in the system 15 may be controlled by the computer 5, which may be executing some or all of one or more software program on one or more processors and employing various memory/storage devices as described below, to monitor and calculate the effectiveness of the hand cleaning performed by the user. The software implementing the functions, methods, and processes of the present invention may be stored as instructions on transitory and/or non-transitory computer-readable media and executed by one or more processors in the computer 5 as well as remotely, such as in the management system.

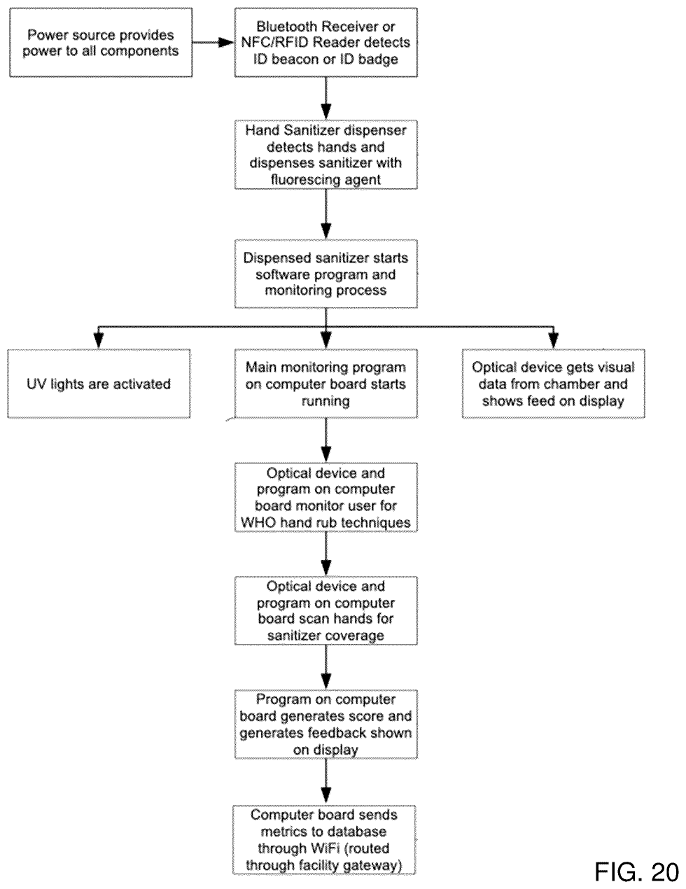

FIG. 20 depicts exemplary component process flows that may be employed in the system 15, such as those depicted in FIGS. 1-18. Initially, power source 4 provides power to all components. Bluetooth 7 or NFC/RFID receiver 8 detects ID beacon or ID badge. Hand Sanitizer dispenser 9 detects hands and dispenses sanitizer with fluorescing agent. Dispensing of the sanitizer may start the software program 16 and monitoring process. Main monitoring program on computer 5 starts running, UV lights 2 are activated, detector 3 collects visual data and provides the data to the computer 5, which process the data and displays it on the display 6. The software may analyze videos or successive images to 1) identify hand rubbing techniques being used, 2) identify the extent of hand coverage during the sanitization process, 3) determine the duration of the sanitization, 4) calculate a score reflective of the coverage, 5) provide the score and optionally feedback to the user via the display, and 6) optionally store information about the sanitization process with the user information on the computer 5 and/or remotely in a database that may be associated with a management system.

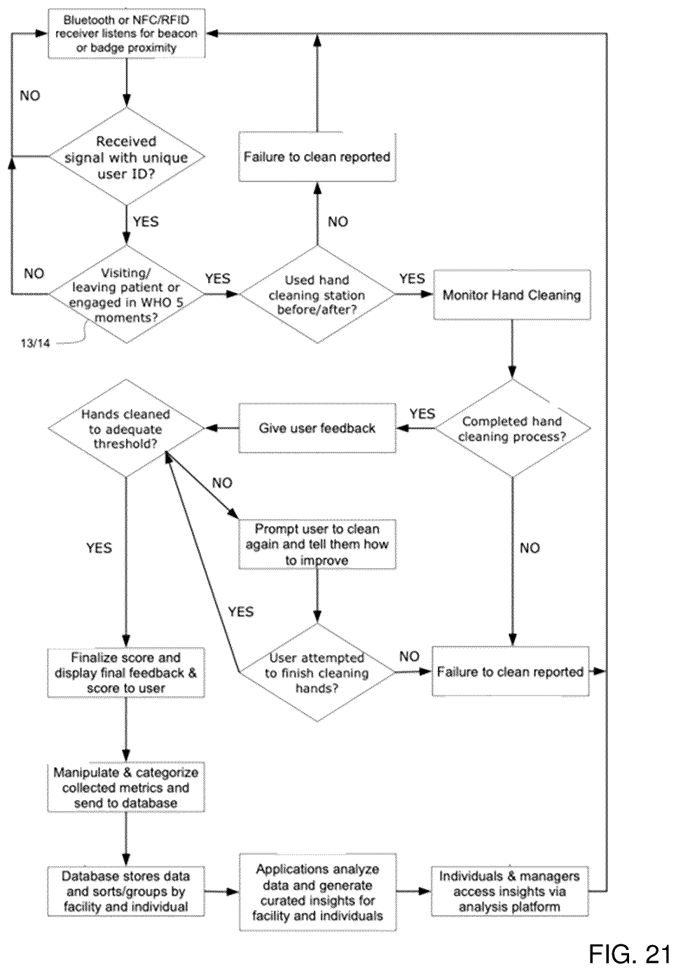

FIG. 21 provides exemplary process flows of the software and component and user interactions, and the experience overall with various embodiments, such as those depicted in FIGS. 1-18. Initially, the Bluetooth or NFC/RFID receiver listens for a beacon or signal from a proximate transmitter. When a signal is received, the software may determine if the signal is from a registered user or not. If not, the software may prompt the user to complete a profile or proceed as a guest. If no response is received to the prompt, the software will return to listening mode and await the next signal. The user may then be identified as someone that needs to engage in hand sanitization, such as people visiting or leaving patients or healthcare workers engaged in the WHO 5 moments of hand hygiene. If not, the software may return to the listening mode. If yes, then the software monitors for the commencement of the hand sanitization process. If the process is not commenced, the software may generate a failure to clean report to be stored including the user information and/or report to a management system and people who monitor cleaning performance. If the process is commenced, the software monitors the sanitization process. If the process is not completed, the software may present an incomplete sanitization message on the display and report and record a failure to complete sanitization.

If the sanitization is completed, the system 15 may provide feedback to the user in terms of tips for improved sanitization and a score reflecting the quality of the sanitization. If the score exceeds a threshold, the user is informed of the successful sanitization and the score and other information from the process recorded, reported, and stored, associated with the user profile. If the score does not exceed a threshold, the user is requested to further sanitize their hands and the system 15 may provide suggestions for improving the score, such as focusing one's cleaning on one's thumbs, fingertips, back of hand, etc, and employing specific techniques to do so. If the user does not complete the sanitization, then the failure is reported and recorded.

The sanitization data may be manipulated & categorized to generate various metrics and stored in the computer and/or sent to a database for remote storage. Reports may be generated and insights provided to various individuals involved with overseeing and improving the sanitization process.

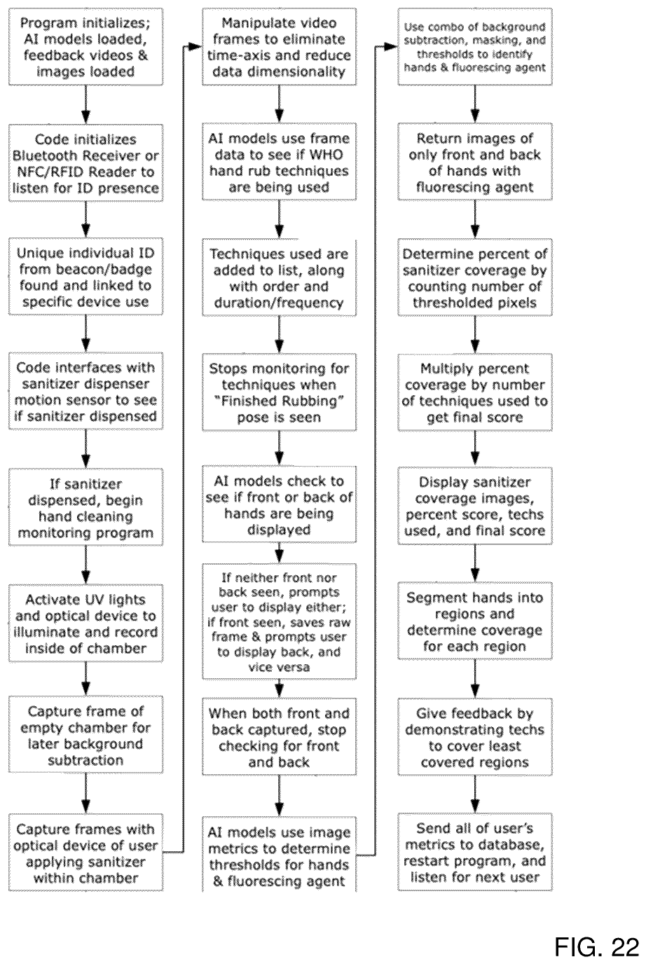

FIG. 22 depicts additional software process flow details that may be employed in the system 15. In step 1, the software initializes; AI models are loaded, feedback videos & images loaded. In step 2, the software initializes Bluetooth receiver and/or NFC/RFID Reader to listen for ID presence. Unique individual ID from beacon/badge or other device may be found and linked to specific device use or new profiles generated for new and guest users. The software may interface with the sanitizer dispenser and any motion sensors to see if sanitizer dispensed. If sanitizer is dispensed, the hand cleaning monitoring program is initialized, activating the UV lights and optical device to illuminate and record activity inside of chamber 1. The software may capture an image (aka frame) of the empty chamber for later background subtraction, if not already or recently stored. Video and/or images of the user applying sanitizer within chamber are then captured.

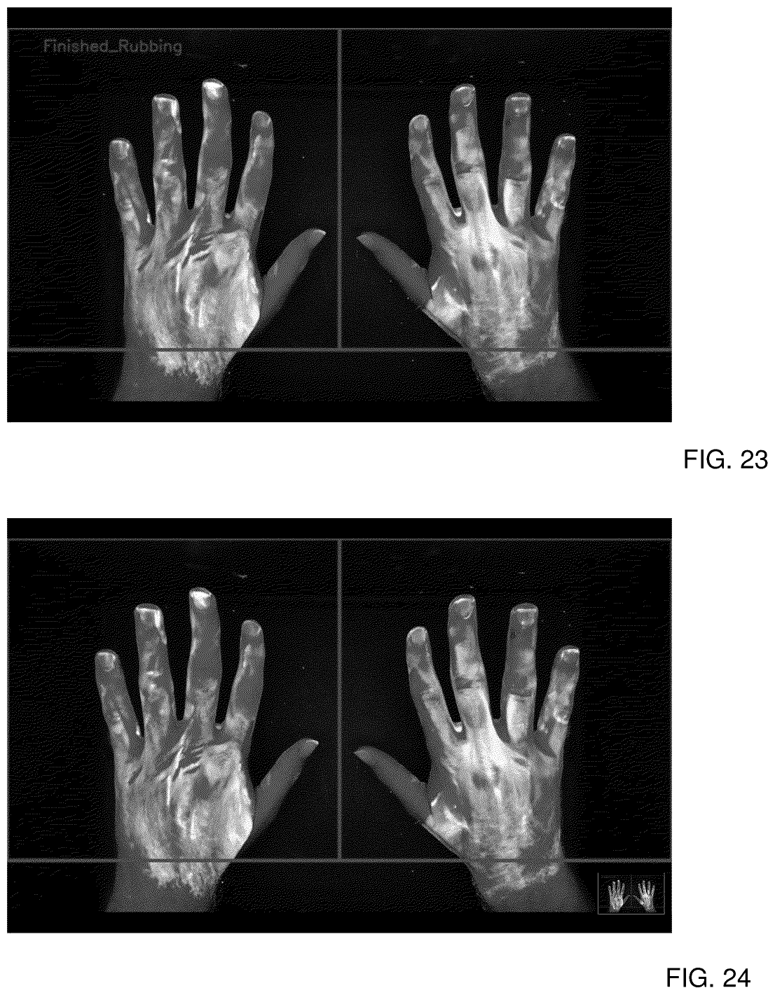

The software may then manipulate video images to eliminate the time-axis and reduce data dimensionality. AI models may use the image data to determine if any World Health Organization (WHO) or other hand rub techniques are being used while the user sanitizes their hands. Techniques used may be added to a list, along with order and duration/frequency of the techniques. The software may stop monitoring when no movement is detected and/or the chamber is empty or when a “finished rubbing” hand position is assumed, e.g., hands separated, top or bottom showing with fingers extended and spread out, see FIG. 23. When the user is finished sanitizing their hands, AI models check to see if either the front or back of hands are being displayed. If neither front nor back of the hand is seen, the software instructions prompt the user to display either side. If the front of the hand is detected, one or more raw images/frames are stored and the user is prompted to display the back of the hand and vice versa. When both front and back images are captured, then software instructions proceed to use AI models or other metrics to compare the images with the thresholds for acceptable sanitization. The software may use background subtraction, masking, and thresholds to identify hands & fluorescing agent. The metrics and AI models may involve various parameters, such as percentage of hand sanitized, locations of sanitized and unsanitized areas, hand washing techniques used, duration, etc. to determine whether the threshold is met and additional instructions and recommendations to provide to the user and management system for immediate and/or future implementation.

The software may display images showing only front and back of hands with fluorescing agent. The software may determine a percent of sanitizer coverage by, for example, counting number of thresholded pixels, and multiply percent coverage by various factors and weighing techniques to get final score.

The hands may be segmented for display and to determine the sanitizer coverage in each hand region for the purposes of giving targeted feedback to the user both in the moment so that they may sanitize said regions to more completely clean their hands, and to the user and system administrators post-cleaning regarding performance trends and potential techniques and strategies to improve sanitization of those regions. Some or all of the data collected during the process may be stored locally in the computer 5 and/or management system that may be local or remote to the system 15 and reported to various personnel.

Other embodiments of the processes and methods described with respect to FIGS. 20-22 may be implemented as well by the skilled artisan. For example, the data collected while the user interacts with the system 15 may be converted into a numerical score, first as an absolute percentage. To do this for the embodiment with the fluorescing agent and visible light camera as the detector 3, the hand is first segmented from the background through background subtraction and thresholding the pixel values of the image, then by thresholding the separate pixel values to determine the amount of sanitizer or fluorescing germ-proxy agent on one's hand and/or by using the hand tracking to determine the areas rubbed with the hand sanitizer or germ-proxy agent and soap and water and the total amount of pixels contained therein. The percentage is then calculated by dividing the amount of pixels thresholded to be sanitizer or fluorescing germ-proxy agent and/or pixels corresponding to areas rubbed by the total amount of pixels thresholded to be the hand. For hand sanitizer, the percentage may represent the amount of coverage, and for hand washing, it may represent the amount of the germ-proxy agent removed.

For the embodiment without a fluorescing agent and a thermal camera as the detector 3, the segmentation of the hand may first show the hands as being warmer than the background, and second show the areas of the hand that are cooler as the areas that are covered by the sanitizer. Determining the percent coverage may be done by counting the number of pixels that fall into the range that represents the cooler sanitizer category. The spots missed by the user may be highlighted and shown on the display 6, alongside the percentage score, etc. The user may be prompted to apply hand sanitizer or germ proxy agent again if their score does not meet a high enough threshold value. The software running on the computer 5 may also show techniques on the display 6 that may be used to cover or clean the missed areas, as well as achieve broader coverage or removal overall. The user may be prompted or request, to repeat the process if the score is not as high as desired or if the score does not meet a threshold level. As noted with other embodiments, the raw coverage score may be converted into points, which can be used for gamification and performance tracking to incentivize continued and efficacious use.

With regard to the hand-rubbing techniques, the systems 15 may employ deep learning models to train the software for video gesture recognition that indicate the use of various hand rubbing techniques. The data used to train these models may include videos of both proper and improper execution of various techniques, as well as actions that correspond to no techniques, labeled as such, in order to identify both. Additionally, the video data collected while a player cleans their hands in a use of the device may be collected, labeled, and used to augment the training data, in order to make the models more robust, as well as identify which techniques are most effective, which are easiest to do properly, the best order for best results, etc. While the skilled artisan may implement the video analysis software as desired, it is generally preferable to minimize the computational intensity while still generating highly accurate results, so that low-power, low-cost single board computers 5 may be used running off batteries as the power source 4.

The software will be running in the background while the detector 3 is monitoring the sanitizer application or hand washing, and may log the different techniques used, the amount of repetitions of each technique, and whether or not the techniques were effectively used to achieve proper coverage or removal. When implementing gesture analysis for example, each of the 6 WHO techniques may further be divided into 9 distinct gestures for left & right hand delineation. The scoring multiplier may depend on the number of the gestures used during the sanitization. Instructions on the various techniques may be provided on the display 6 or elsewhere for review by the user.

Once a user has completed the sanitization process, data related to their performance and scoring may be shown on the display (6). As mentioned earlier, the user may be shown the spots they missed on each use of the device, as well as techniques they can use to cover or clean those spots. Additionally, they may be shown what they did correctly as well, to reward and encourage them, with the spots they covered or removed effectively highlighted, and the techniques they used, if any, listed off alongside their multiplier. It may also then show their percentage coverage score and how various multipliers are applied to that score to create their final point score. Finally, some fun graphics may be used to acknowledge their score depending on how the player did, like a smiley emoji, angry emoji, character giving a thumbs up/down or frowning/smiling, etc. The data may be stored locally and/or sent to a remote management system for storage and linked to the user's or guest account. Once the data is transmitted to the database, it can be viewed and analyzed in the analytics platform by the user, as well as the system 15 operators/supervisors at the facility. When the system 15 is not in use, the display 6 may be used to show educational materials, sponsored content, or advertisements.

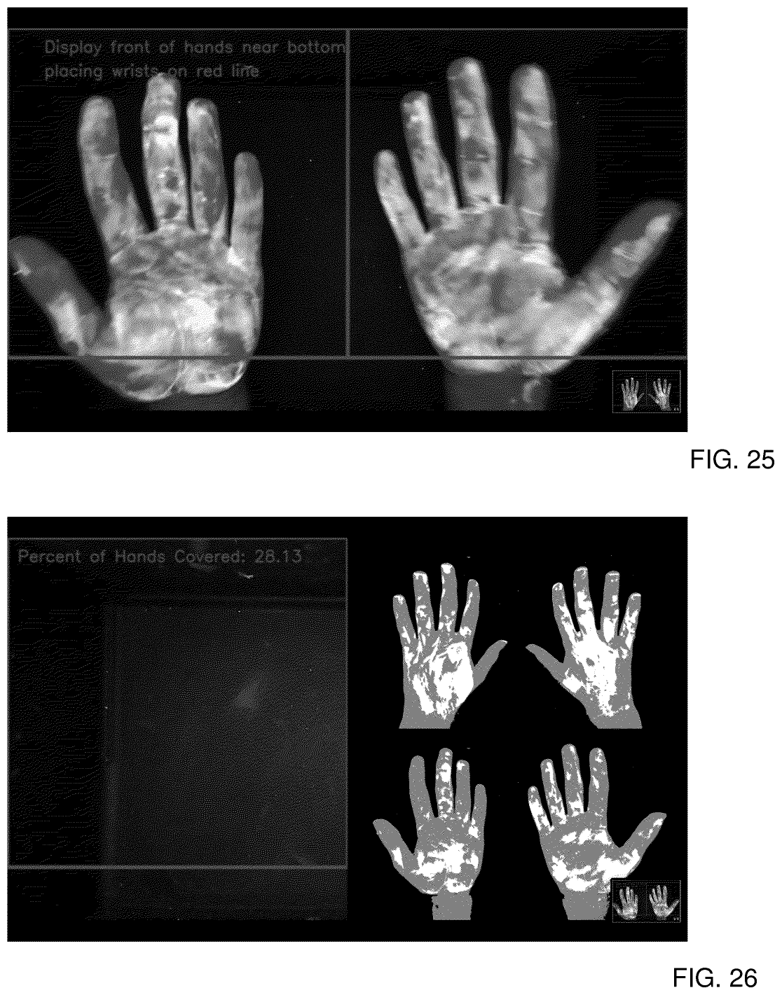

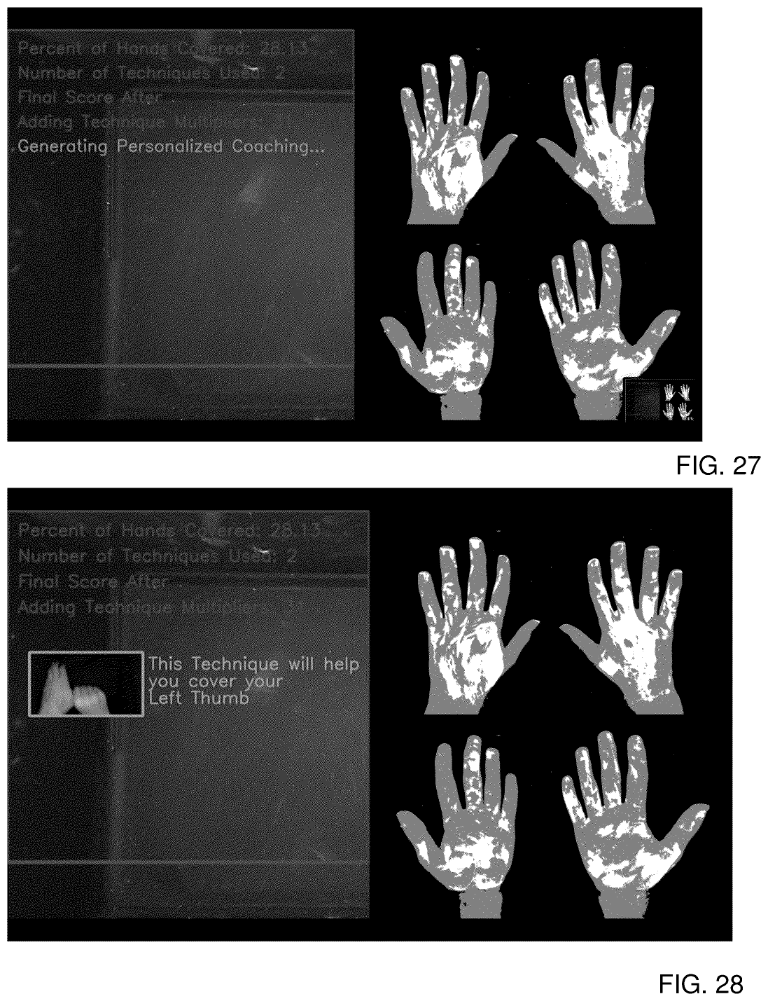

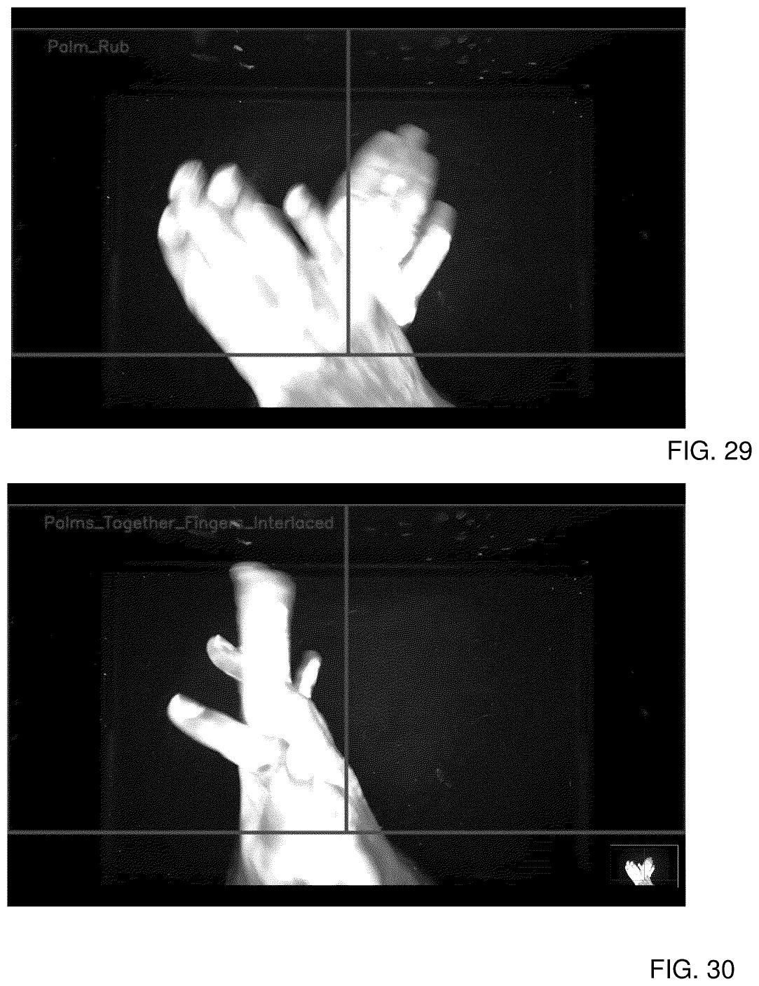

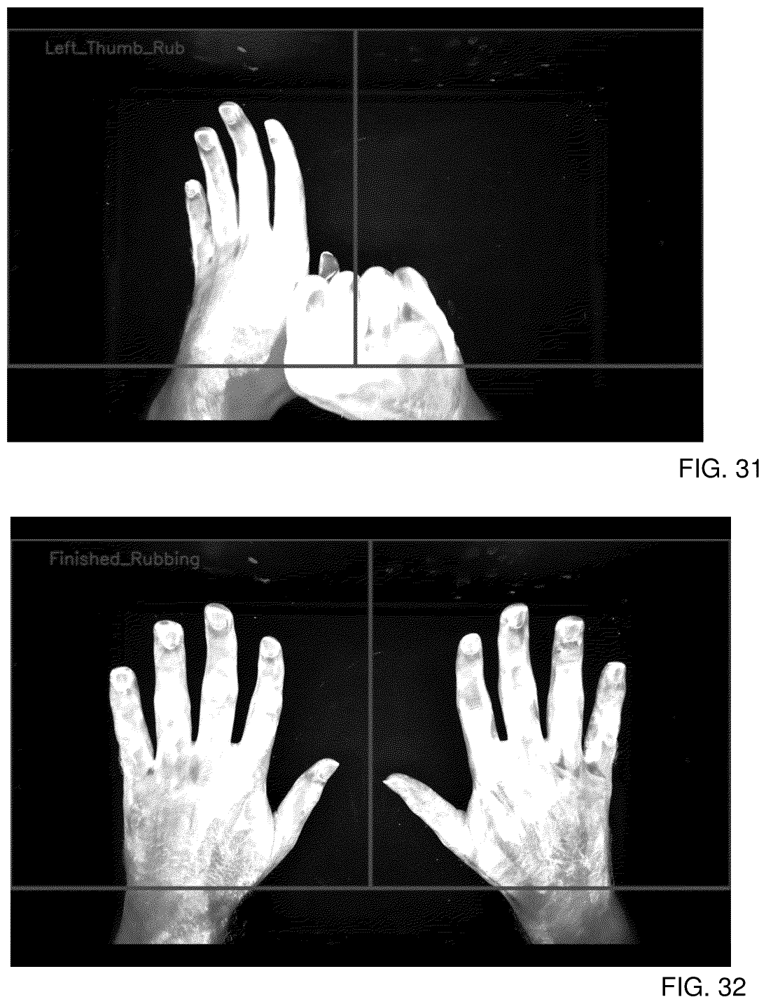

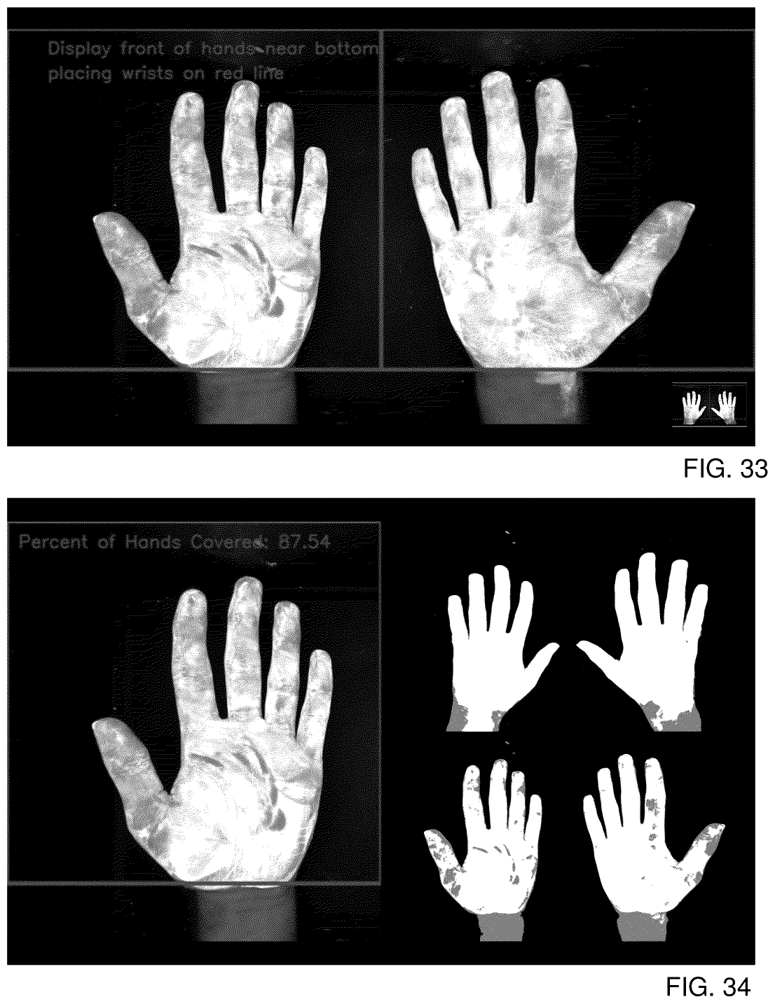

FIGS. 23-34 show exemplary displays involved in the sanitization monitoring and analysis process using the system 15. FIG. 23 shows a user's hands in the finished rubbing or monitoring position. The hands are in the hand detection area with the fingers spread apart to allow the illumination and detection of the hands. FIG. 24 shows the back of the user's hands and the difference in appearance between sanitized and unsanitized areas. FIG. 25 shows the front of the user's hands. The hands are slightly out of the hand detection area, so the system 15 presents the user with a message to move their hands to be better located in the hand detection area, stating “Display front of hands near bottom placing wrists on the red line”. FIG. 26 shows the results of the analysis to the user, namely “Percent of Hands Covered: 28.13” along with images of the user's hands showing sanitized and unsanitized areas. FIG. 27 provides additional information regarding the hand sanitization analysis and informs the user that personalized coaching is being generated based on the analysis. For example, since the user's thumbs were not efficiently sanitized, in FIG. 28, the user is presented with a technique for improving sanitization of the thumbs. FIG. 29 shows a user engaging in a palm rubbing cleaning technique. FIG. 30 shows a user engaging in a palms together fingers interlaced cleaning technique. FIG. 31 shows a user engaging in a thumb cleaning technique. FIG. 32 shows a user with their hands in the finished rubbing or monitoring/inspection position with the back of the hands visible to the detector. FIG. 33 shows a user's hands in the inspection position with the front of the hands visible to the detector.

FIG. 34 shows the results of the analysis, which is an 87.54 percent coverage, which is a dramatic improvement over the initial sanitization attempt. A comparison of FIG. 26 and FIG. 34 is a vivid display of the potential improvement in hygiene that may be brought about by the present invention.

As demonstrated above, systems 15 of the present invention may be used to improve health outcomes by getting individuals to become more invested in their personal hand hygiene, and more motivated and able to ensure they improve their hand hygiene habits and sustain them. Currently, there is no method or technology by which hand cleaning efficacy can be directly measured during the process, thus there is no way for healthcare workers or others to have quantified knowledge and insight into the actual cleanliness of their hands. Most protocols are based on performing the sanitization for a set period of time that may be correlated to hand cleaning efficacy. The present invention may be used to provide real-time insight to improve the process and the level of sanitization.

Hand sanitization may be gamified to further incentivize good sanitization skills and habits by allowing both the user and management to view their results and personal statistics in the analytics platform later. First, a user may link their individual profile to the system 15 and their particular use of the system 15 by identifying themselves at the system 15 as previously described. If the user does not have an existing profile, the user may be prompted to create a profile or proceed as a guest.

As noted, the software running on the computer 5 may monitor the user to determine whether various hand washing techniques are used, e.g., WHO's 6 recommended Hand Rub techniques, and other sanitization measures are performed and the duration. When the sanitization is complete, the software may calculate a percentage coverage sanitization score and then augment the percentage score with additional points for using various techniques, the duration of rubbing, and other measures that may be used to produce a final score (representing both a gamification of the experience, as well as a way to quantify cleaning beyond mere coverage/removal, as the hand rubbing is important as well).

The scoring can depend upon customer preferences, such as awarding no points if their percentage score does not reach a certain coverage threshold, and less points for less than optimal coverage and a lack of techniques, etc. For example, if the percentage score is in the 25th or lower percentile of mean score values, they'll get no points; if they're in the 25th to 75th percentile, they'll get half points; and if they're in the 75th percentile or above, they'll get full points.

Another way to gamify this from the medical facility perspective, which uses percentiles for relative performance incentivization, would be to use the percentiles as qualifications for rewards, instead of not giving users points. For example, users in the top score quartile might get a high monetary bonus, users in the second highest quartile might get a smaller bonus, and users in the bottom two quartiles might not get anything. Or instead of individual compensation, donations to the top users' favorite charities might be made. Furthermore, the percentiles may be dynamic and based on overall users' performance, so that as users continue to improve their hand sanitizing technique and results, achieving the higher percentiles may become progressively harder.

In other embodiments, the scores may be placed along a hyperbolic tangent scale, may be of the function about 50tanh(0.05x−2.5)+50 to put it on a 0-100 scale for X (percentage score) and Y (percent of percentage score converted into points), which penalizes scores below the middle value of 50 more so than the values above 50, and where the marginal increase in the percent of points received from the percentage score really levels off as 100 is approached. Other embodiments may be explored to execute this concept of thresholded and/or scaled point awarding. In cases where the user does not achieve full points or close to it, they may be prompted by the display 6 to improve their score by applying sanitizer or germ proxy agent again, showing areas that were missed, and the techniques that are most helpful in cleaning the user's most missed areas. If they choose to play again and use any recommended techniques, and cover or wash the missed areas, they will be rewarded with a higher score.

Now, like any game, a higher score comes with rewards. In this case, there are a few incentives that will motivate people to get higher scores, and therefore achieve greater hand hygiene. In various embodiments, users may have their average scores and total points earned displayed on leaderboards for the particular facility, area, etc., generated by aggregating the scores of all users, which will give individuals a sense of relative accomplishment. Additionally, individuals may use scores to compete against their friends and colleagues at their facility, inspiring them all to try to clean their hands as well as possible, to rise above their competitors. The public scoring may be displayed as an aggregate for different healthcare worker positions (e.g. nurses vs. doctors vs. surgeons), disciplines (e.g. pediatric vs. geriatrics vs. anesthesiology vs. internal medicine, etc.), shifts, wings of the facility, etc. Another way that points may be used to further incentivise frequent and high-scoring use is to give points value outside of the facility. This may be done by partnering with vendors and stores to make it so points may be redeemed for discounts, coupons, rewards, prizes, etc.

In various embodiments and scenarios, it may be desirable to have penalties for either not using the systems up to the standards set by the facility, or by not getting high enough percent score/point totals. The penalties may be tied into pre-existing disciplinary procedures of the facilities. For example, warnings for individual incidents when a healthcare worker is observed to not engage in hand hygiene activities when they should have, educational materials/classes if a certain amount of warnings have been given, and even a disciplinary writeup to superiors if the individual still hasn't improved their hand hygiene behaviors.

The penalties may focus more on showing the individual their shortcomings and teaching them how to overcome them. For example, generating individual insights that show users when/where/how they don't perform well, what they can do to improve, and reminders to their mobile device/ID device/from their supervisors/etc. to engage in hand hygiene behaviors until they've improved enough to no longer warrant them.

In addition to all the individual profiles and metrics that are part of the experience, the system and the data it collects may be used to create insights on an analytics platform to be used by managers, directors of infection prevention, nursing heads, chief quality/patient safety officers, etc. All scores and other metrics may be linked to the analytics platform, where users, administrators, and others may track performance trends and receive analytics-driven insights. Employers may want to use tracking for compliance, monitoring, and intervention if needed. Examples include, but are not limited to:
Average/instanced hygiene score, as well as running total
Average/instanced % scores
Average/instanced number/type of WHO Hand Rub techniques used
Areas of hand missed most/cleaned best
Compliance & performance before/after visiting patients
Compliance & performance trends throughout HCW shifts
Compliance & performance trends throughout different areas of the facility
Frequency & total number of compliance events
What individual compliance & performance was before interacting with patients that acquired an infection, as well as trends for infection following their interaction
Infection risk scores & recommendations for intervention for individual healthcare workers, wings, shifts, etc, enabled through AI analysis

The analytics platform provides the ability for users to create, view, and take action from insights regarding sanitization practices that are hitherto nonexistent, which may prove invaluable for healthcare facilities in understanding and preventing infections and outbreaks. The present invention takes hand hygiene from an unquantifiable risk to a procedure that can be measured and therefore improved.

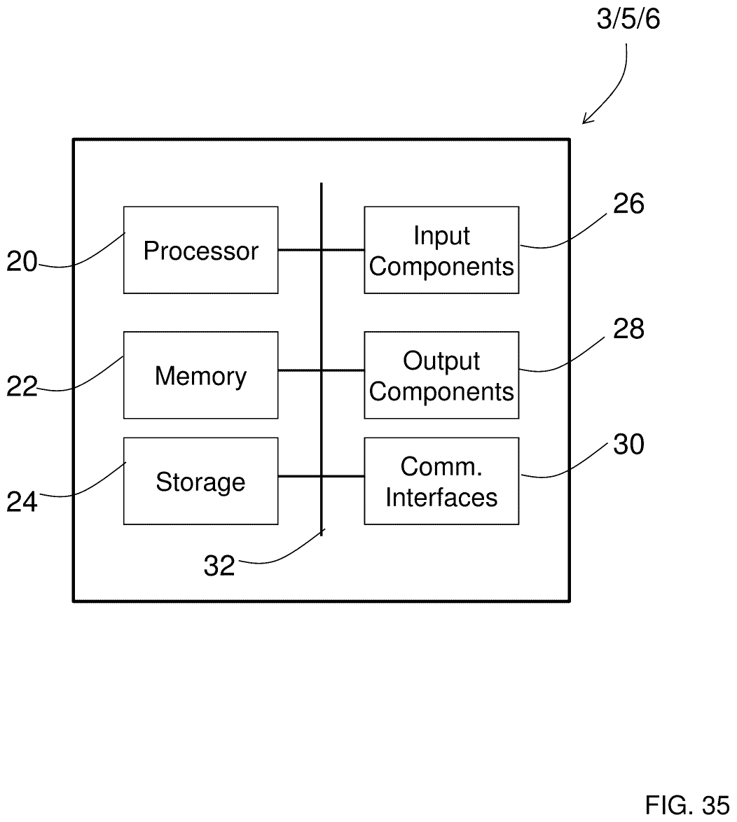

FIG. 35 illustrates exemplary component embodiments of various computing resources, such as computer 5, the detector 3, display 6, illumination device 2, etc., that may be employed in the system 15, and running various applications. The computing resources may each include one or more processors 20, memory 22 and other storage 24, input components 26, output components 28, communication interfaces 30, as well as other components that may be interconnected as desired by the skilled artisan via one or more buses 32. As previously described, the components of the various computing resources may often be configured as a single device or multiple interdependent or stand-alone devices in close proximity and/or distributed over geographically remote areas.

Processor(s) 20 may include one or more general or Central Processing Units (“CPU”), Graphics Processing Units (“GPU”), Accelerated Processing Units (“APU”), microprocessors, and/or any processing components, such as a Field-Programmable Gate Arrays (“FPGA”), Application-Specific Integrated Circuits (“ASIC”), etc. that interpret and/or execute logical functions. The processors 20 may contain cache memory units for temporary local storage of instructions, data, or computer addresses and may be implemented as a single-chip, multiple chips and/or other electrical components including one or more integrated circuits and printed circuit boards that implements and executes logic in hardware, in addition to executing software.

Processor(s) 20 may connect to other computer systems and/or to telecommunications networks as part of performing one or more steps of one or more processes described or illustrated herein, according to particular needs. This can be accomplished through APIs or other methods, using FHIR format or other health-specific format. Moreover, one or more steps of one or more processes described or illustrated herein may execute solely at the processor 20. In addition, or as an alternative, one or more steps of one or more processes described or illustrated herein for execution in one processor may be executed at multiple CPUs that are local or remote from each other across one or more networks.

The computing resources of the system 15 may implement processes employing hardware and/or software to provide functionality via hardwired logic or otherwise embodied in circuits, such as integrated circuits, which may operate in place of or together with software to execute one or more processes or one or more steps of one or more processes described or illustrated herein. Software implementing particular embodiments may be written in any suitable programming language (e.g., procedural, object oriented, etc.) or combination of programming languages, where appropriate.

Storage may include various types of memory 22, e.g., Random Access Memory (“RAM”), Read Only Memory (“ROM”), and/or another type of dynamic or static memory devices, such as flash, magnetic, and optical memory, etc. that stores information and/or instructions for use by processor 20. The memory 22 may include one or more memory cards that may be loaded on a temporary or permanent basis. Memory 22 and storage 24 may include a Subscriber Identification Module (“SIM”) card and reader.

Other storage components 24 may be used to store information, instructions, and/or software related to the operation of the system 15 and computing resources. Storage 24 may be used to store operating system, executables, data, applications, and the like, and may include fast access primary storage, as well as slower access secondary storage, which may be virtual or fixed.

Storage component(s) 24 may include one or more transitory and/or non-transitory computer-readable media that store or otherwise embody software implementing particular embodiments. The computer-readable medium may be any tangible medium capable of carrying, communicating, containing, holding, maintaining, propagating, retaining, storing, transmitting, transporting, or otherwise embodying software, where appropriate, including nano-scale medium. The computer-readable medium may be a biological, chemical, electronic, electromagnetic, infrared, magnetic, optical, quantum, or other suitable medium or a combination of two or more such media, where appropriate. Example computer-readable media include, but are not limited to fixed and removable drives, ASIC, Compact Disks (“CDs”), Digital Video Disks (“DVDs”), FPGAs, floppy disks, optical and magneto-optic disks, hard disks, holographic storage devices, magnetic tape, caches, Programmable Logic Devices (“PLDs”), Secure Disk Cards (“SD Cards”), RAM devices, ROM devices, semiconductor memory devices, solid state drives, cartridges, and other suitable computer-readable media.

Input components 26 and output components 28 may include various types of Input/Output (“I/O”) devices. The I/O devices often may include a Graphical User Interface (“GUI”) that provides an easy to use visual interface between the user and system 15 and access to the operating system or application(s) running on the devices.

Input components 26 receive any type of input in various forms from users or other machines, such as touch screen and video displays, keyboards, keypads, mice, buttons, track balls, switches, joy sticks, directional pads, microphones, cameras, transducers, card readers, voice and handwriting inputs, and sensors for sensing information such as biometrics, temperature & other environmental conditions, such as air quality, etc., location via Global Positioning System (“GPS”) or otherwise, accelerometer, gyroscope, compass, actuator data, which may be input via a component in the computing resource and/or received via one or more communication interfaces 30.

Output component 28 may include displays, speakers, lights, sensor information, mechanical, or other electromagnetic output. Similar to the input, the output may be provided via one or more ports and/or one or more communication interfaces 30.

Communication interface 30 may include one or more transceivers, receivers, transmitters, modulators, demodulators that enable communication with other devices, via wired and/or wireless connections. Communication interface 30 may include Ethernet, optical, coaxial, Universal Serial Bus (“USB”), Infrared (“IR”), Radio Frequency (“RF”) including the various Wi-Fi, WiMax, cellular, and Bluetooth protocols, such as Bluetooth, Bluetooth Low Energy (BLE), Wi-Fi (IEEE 802.11), Wi-Fi Direct, SuperWiFi, 802.15.4, WiMax, LTE systems, LTE Direct, past, current, and future cellular standard protocols, e.g., 4-5G, or other wireless signal protocols or technologies as described herein and known in the art.

Bus(es) 32 may connect a wide variety of other subsystems, in addition to those depicted, and may include various other components that permit communication among the components in the computing resources. The bus(es) 32 may encompass one or more digital signal lines serving a common function, where appropriate, and various structures including memory, peripheral, or local buses using a variety of bus architectures. As an example and not by way of limitation, such architectures include an Industry Standard Architecture (“ISA”) bus, an Enhanced ISA (“EISA”) bus, a Micro Channel Architecture (“MCA”) bus, a Video Electronics Standards Association Local Bus (“VLB”), a Peripheral Component Interconnect (“PCI”) bus, a PCI-eXtended (“PCI-X”) bus, a Peripheral Component Interconnect Express (PCIe) bus, a Controller Area Network (“CAN”) bus, and an Accelerated Graphics Port (“AGP”) bus.

The computing resources of the system 15 may provide functionality as a result of the processors 20 executing software embodied in one or more computer-readable storage media residing in the memory 22 and/or storage 24 and logic implemented and executed in hardware. The results of executing the software and logic may be stored in the memory 22 and/or storage 24, provided to output components 28, and transmitted to other devices via communication interfaces 30, which includes cloud storage and cloud computing. In execution, the processor 20 may use various inputs received from the input components 26 and/or the communications interfaces 30. The input may be provided directly to the processor 20 via the bus 32 and/or stored before being provided to the processor 20. Executing software may involve carrying out processes or steps may include defining data structures stored in memory 22 and modifying the data structures as directed by the software.

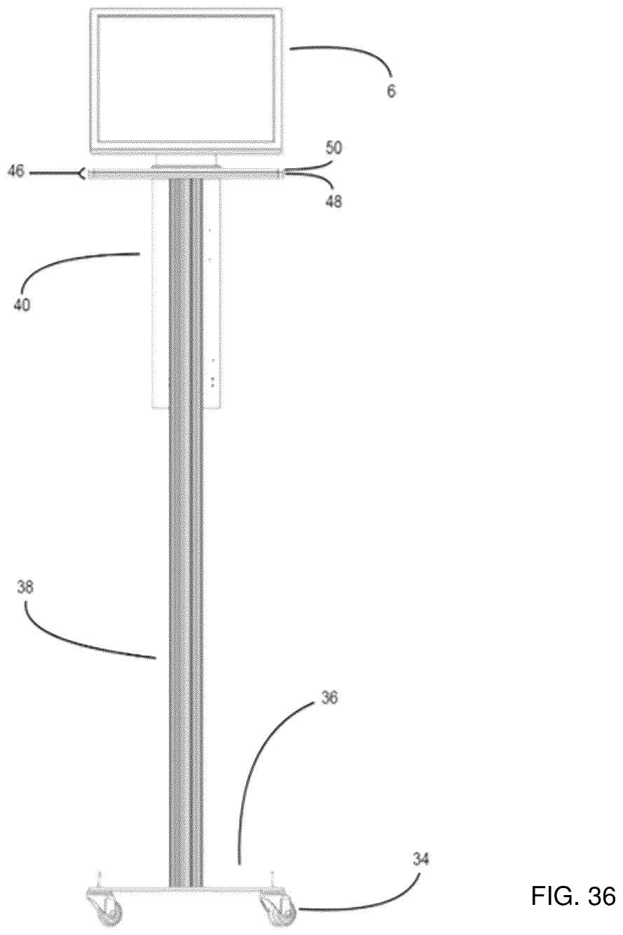

FIGS. 36-43 illustrate alternative embodiments of the system 15 without the chamber and provides for mobility to provide users of the system with additional flexibility in locating and moving the system 15. Embodiments depicted in FIGS. 36-43 will be referred to herein for convenience as “portable”, “open-space”, or “kiosk” embodiments. However, the skilled practitioner will appreciate that portable kiosk configurations can also be employed to include a chamber and/or plumbing connections to enable the use of facility water in the system 15.

As noted in FIGS. 36-43 embodiments, system 15 may be a free-standing, wheeled, portable kiosk, with an open-space area instead of a chamber. As there is no chamber and the system locations may vary, it is not possible to fully control lighting conditions. Therefore, these embodiments may require different techniques than the image thresholding technique that may be used with embodiments with chambers. These techniques may include, but are not limited to, either automatically adjusting the camera settings to preset values and/or using computer vision & artificial intelligence (AI) models to analyze the lighting conditions to determine optimal settings for the camera, instance or semantic segmentation AI models that take image data to generate predictions to classify each pixel as either background, sanitized areas of the hands, or the various regions of the hand, etc. The AI models may be used in conjunction with, or in lieu of, thresholding techniques in the system 15.

Additionally, while these embodiments make use of a wheeled base and standing-height support column, other embodiments may have the open-space design, but other support structures. Examples of this include a shorter version without wheels that can be placed on surfaces, a shorter version with “legs” on each side and all empty space down the center to fit over a sink, or no support structures where the device is instead mounted to the wall or other infrastructure and foldable/collapsable options that can be moved via a case. The common thread being the open-space design that takes up less space and utilizes techniques to generate accurate results without the aid of a chamber to more fully control lighting conditions.

FIG. 36 depicts exemplary frontal views of portable open-space kiosk embodiments of the system 15, which may include wheels 34 or other components that enable easy movement of the system. The system 15 may also rest upon a base 36 to which the wheels 34 are attached and may be held up by a support column 38. The support column 38 of the device may either be fixed or adjustable so that it can accommodate various heights of users, and may be positioned near the center-back of the base 36, in order to both take up less space front-to-back, and counterbalance the hood/overhang 46 for stability.

The system 15 may also include an electronics assembly 40 that contains the various electronics used, including, but not limited to, a terminal strip 42 to take in a power source 4 like a power cable and split the electricity, a power supply 44 module to split the electricity into different voltages for each component, as needed, and a computer 5, which may be similar to those described with other embodiments. The mentioned components in the electronics assembly 40 are not visible from the angle in FIG. 36.

Portable open-space kiosk embodiments of the system 15 may include a hood/overhang 46, in which are housed the UV lights 2 and detector/optical device 3 (both not visible in this view). The hood/overhang 46 may be a horizontal counter that may provide top surface to service as a workspace for the user and a bottom surface for supporting other components. In addition, the hood 46 may include fixed or adjustable vertical side portions (not shown) extending down from one or more edges of the hood 46 to block or impede ambient light from entering the hand detection area similar to the chamber embodiments.

In these embodiments, the user may be instructed to clean/sanitize their hands in the space under the hood/overhang 46, where they may be monitored for technique usage on application of hand cleaner/sanitizer and/or their hands scanned to measure cleaner/sanitizer coverage. The hood/overhang 46 may include a lighting layer 48 in which the UV lights 2 and detector/optical device 3 reside, and a heat sink layer 50 to which the top of the UV lights 2 attach, and which may be used to control the temperature of the lights 2 as need. Additionally, in these embodiments, the UV lights 2 may be integrated as an LED matrix on a printed circuit board, in order to control the lights with functions like dim, on/off, selective on/off for specific lights, etc., instead of LED strips.

A display 6 may rest and/or be attached on or proximate the top surface the hood/overhang 46, or be supported by the column 38 in the space above the hood/overhang 46. The display may be similar to displays described for other embodiments or may be tailored to specific embodiments.

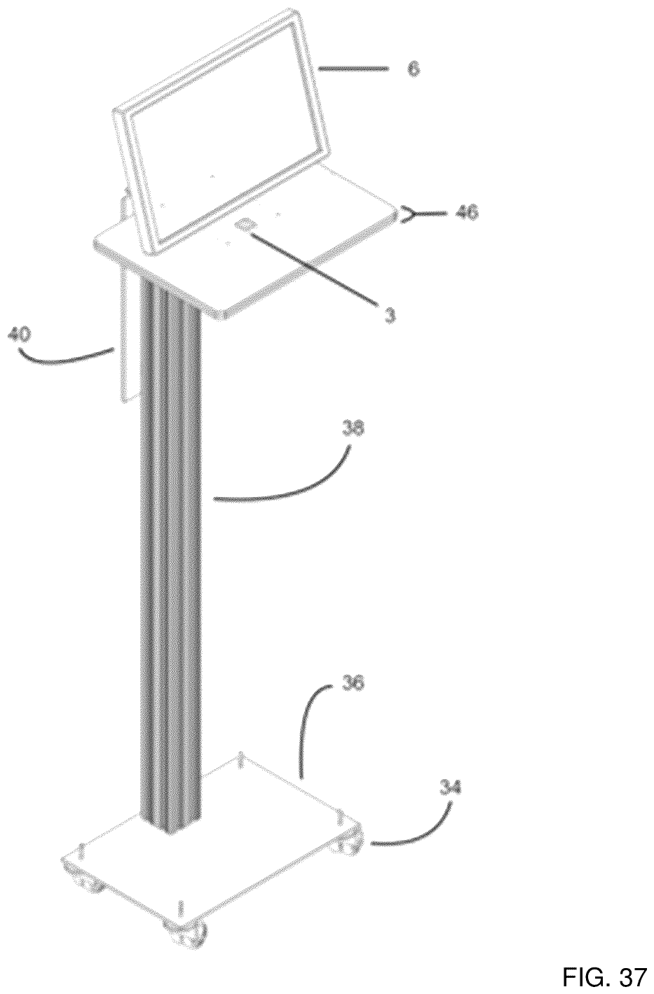

FIG. 37 depicts an exemplary front top perspective view of FIG. 36 embodiments showing the front, left, and top of the system 15, and exemplary locations for the components depicted in FIG. 36. It also shows a possible location of the top of the detector/optical device 3 within the hood/overhang 46.

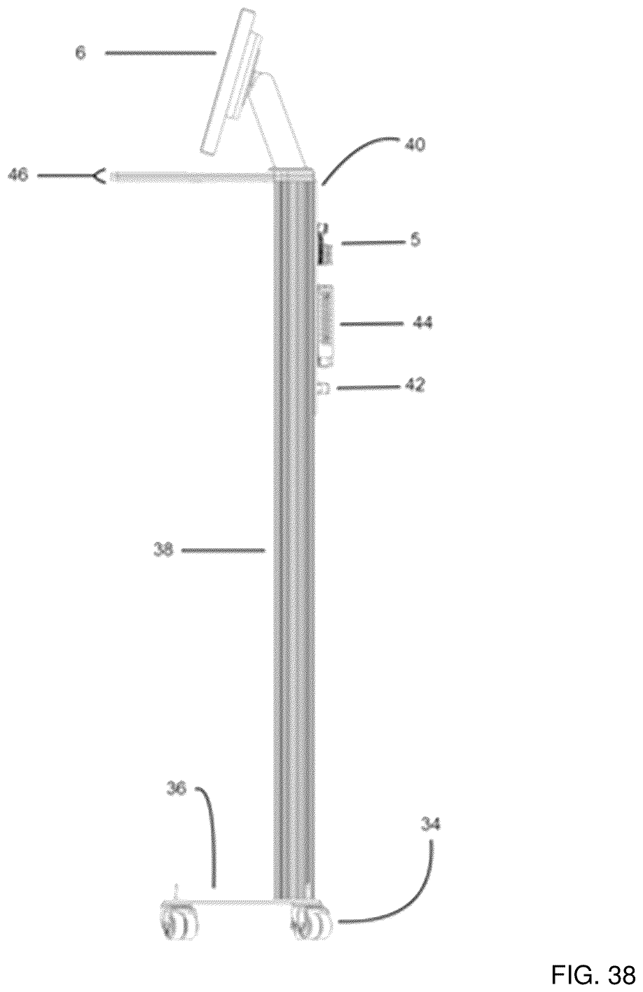

FIG. 38 depicts exemplary right side views of the embodiments of the system 15 depicted in FIGS. 36-37. FIG. 38 depicts the exemplary components shown in FIGS. 36-37, with the addition of the components within the electronics assembly 40. Additionally, for ease of viewing, the walls of the electronics assembly 40 are made invisible here to make the components inside visible, and show their relative location.

The electronics assembly 40 may contain a terminal strip 42 at the bottom of the assembly 40. For ease of use within facilities, it is generally preferred that the device only uses one power cable for the power source 4. Electricity incoming to the terminal strip 42 may be split into various sub-cables to power the various electronics and provide electricity to power supply and batteries 44. In various embodiments, the system 15 will include one or more batteries suitably sized to power the system 15 for a period of time to allow further flexibility in the locating the system 15 with a facility.

The power supply 44 may be positioned as desired with the assembly 40 and configured to receive input electricity from the terminal strip 42 and split the electricity into the various voltages required by the different electronic components, such as 5 volts, 12 volts, and 24 volts, AC or DC. The wiring for each individual electronic component, such as, but not necessarily limited to, the computer 5, UV lights 2, and display 6, may then be attached to corresponding nodes on the power supply 44 that outputs each different voltage.

The electronic assembly 40 may or may not house the computer 5, which may include various components as described in FIG. 35 and are known to those skilled in the art. The computer 5 will generally run software 16 controlling the operation of the system 15. Various components may be connected in the electronic assembly 40, such as wireless receivers 7, motion sensors 10, and other components, such as a keyboard, bluetooth mouse connector, voltage buck converter, and microcontrollers.

The electronics assembly 40 may be configured as desired and generally serves to protect these various electronic components, and also contains wiring, making the system 15 both safe & space efficient.

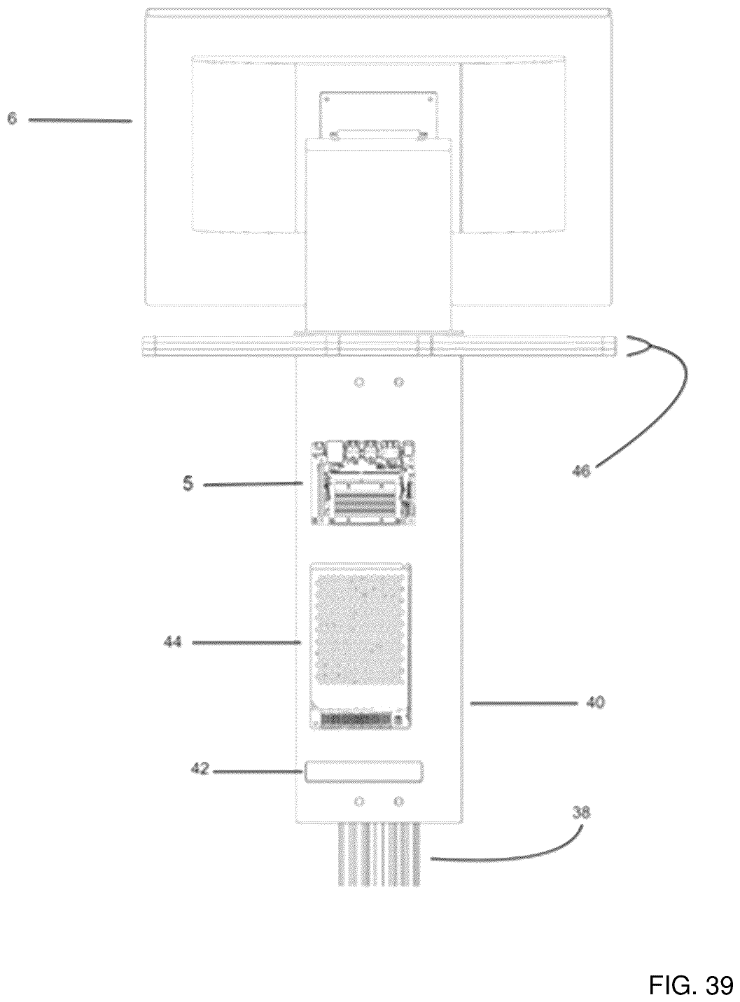

FIG. 39 depicts exemplary back views of the top portion of the embodiments of the system 15 depicted in FIGS. 36-38. FIG. 39 depicts the support column 38, the electronics assembly 40 with walls made invisible, terminal strip 42, power supply 44, computer 5 (which may have wireless receiver 7 attached), hood/overhang 46 containing UV lights 2 and detector/optical device 3 (not shown), and display 6.

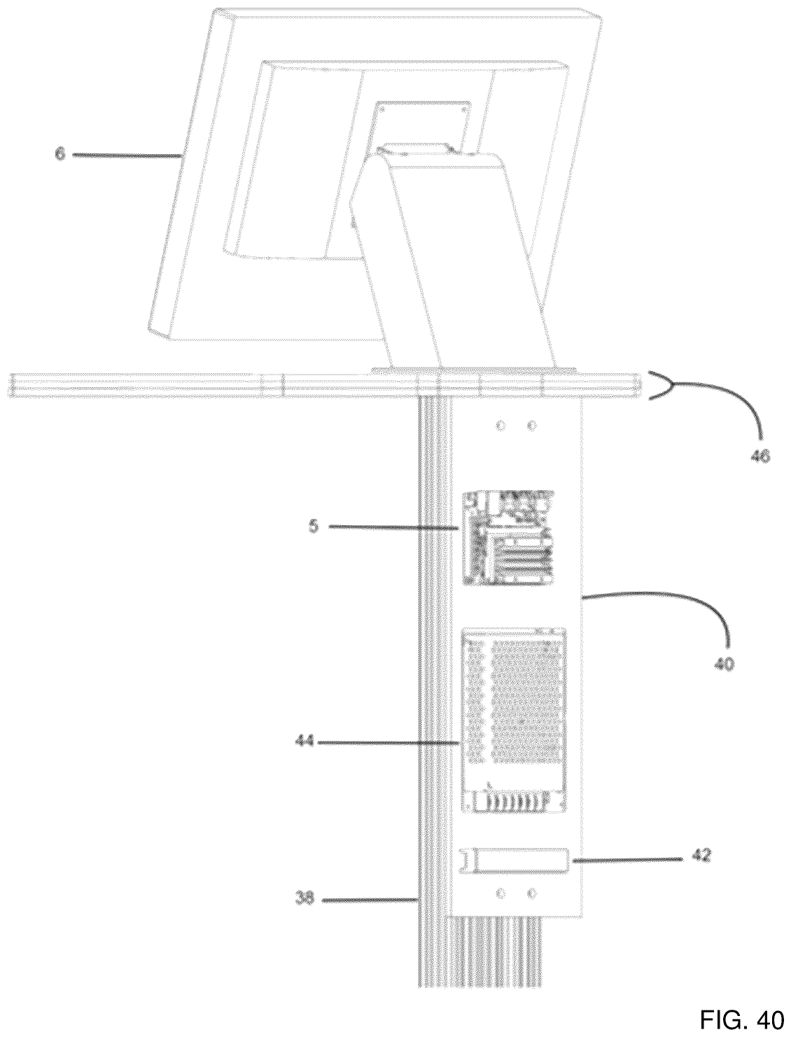

FIG. 40 depicts exemplary back right perspective views of the top portion of the embodiments of the system 15 depicted in FIGS. 36-39. FIG. 40 depicts the support column 38, the electronics assembly 40 with walls made invisible, terminal strip 42, power supply 44, computer 5 (which may have wireless receiver 7 attached), hood/overhang 46 containing UV lights 2 and detector/optical device 3 (not shown), and display 6.

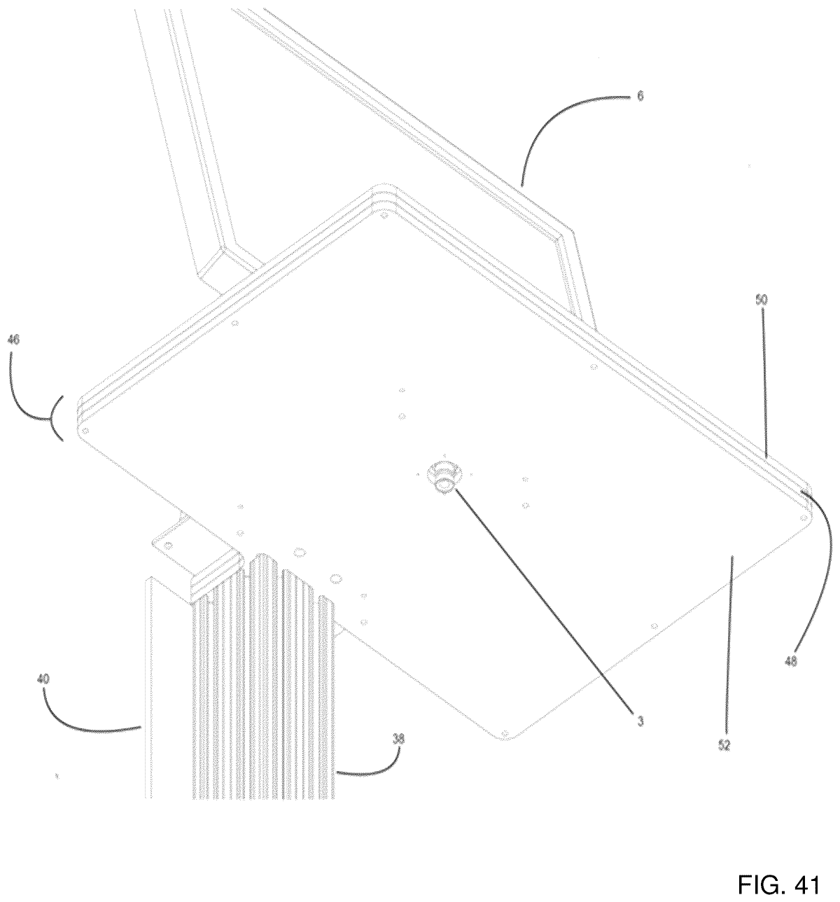

FIGS. 41-43 depict exemplary front left bottom perspective views of the top portion of the embodiments of the system 15 depicted in FIGS. 36-40. FIG. 41 depicts the underside, or bottom surface, of exemplary overhangs/hoods 46 of the system 15, as well as the support column 38, back of the electronics assembly 40, and display 6. FIG. 41 also depicts a location of the detector 3 which may be in the center of the hood/overhang 46 or other location as desired.

FIG. 41 depicts various layers of components that may be mounted to the bottom surface of the hood/overhang 46 that may be employed in various embodiments, such as a middle lighting layer 48 where the UV lights 2 and detector 3 may be placed and a top heat sink layer 50 that may be mounted to the bottom surface of the hood 46, to which the top of the lights are attached and serves to absorb heat generated by the lights and other electronics that may be present, and a bottom lighting cover layer 52 through which the UV lights 2 shine, to which the detector 3 may be attached, and which protects the aforementioned components. The bottom lighting cover layer 52 may be transparent and may be composed of durable materials, such as acrylic or hardened glass.

The various layers of the hood/overhang may be interconnected by holes in which threaded heat-set inserts are placed, or which are threaded directly, so that screws going through all layers hold them together in place.

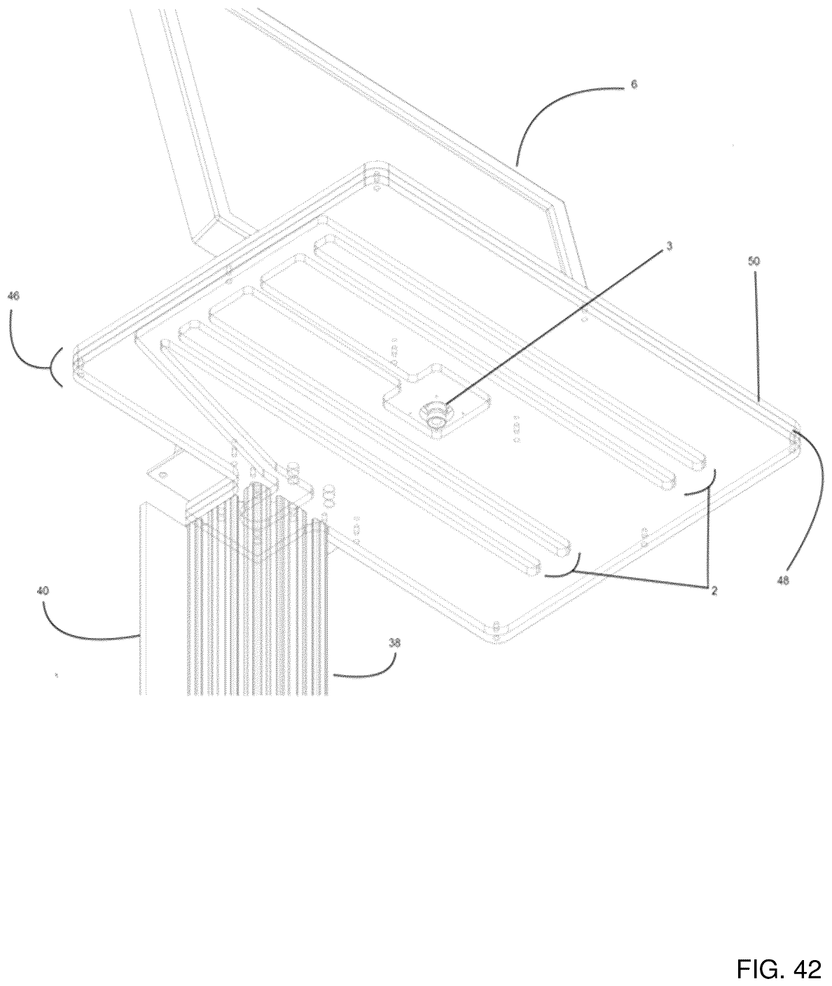

FIG. 42 depicts the bottom light cover layer 52 as invisible, so the UV lights 2 in the middle layer 48 are made visible. The UV lights 2 in this embodiment are shown as being in 4 rows, though other embodiments may have more or less lights and configurations, and may be in the form of LED strips, soldered LED matrices, LED printed circuit boards, etc. and employ other illumination technologies as well. The LEDs may also be in an arrangement other than rows, like a couple of connected rectangular blocks, a singular array with a hole for the detector 3, or circular arrays on either side of the detector 3 and be positioned at various angles relative to vertical.

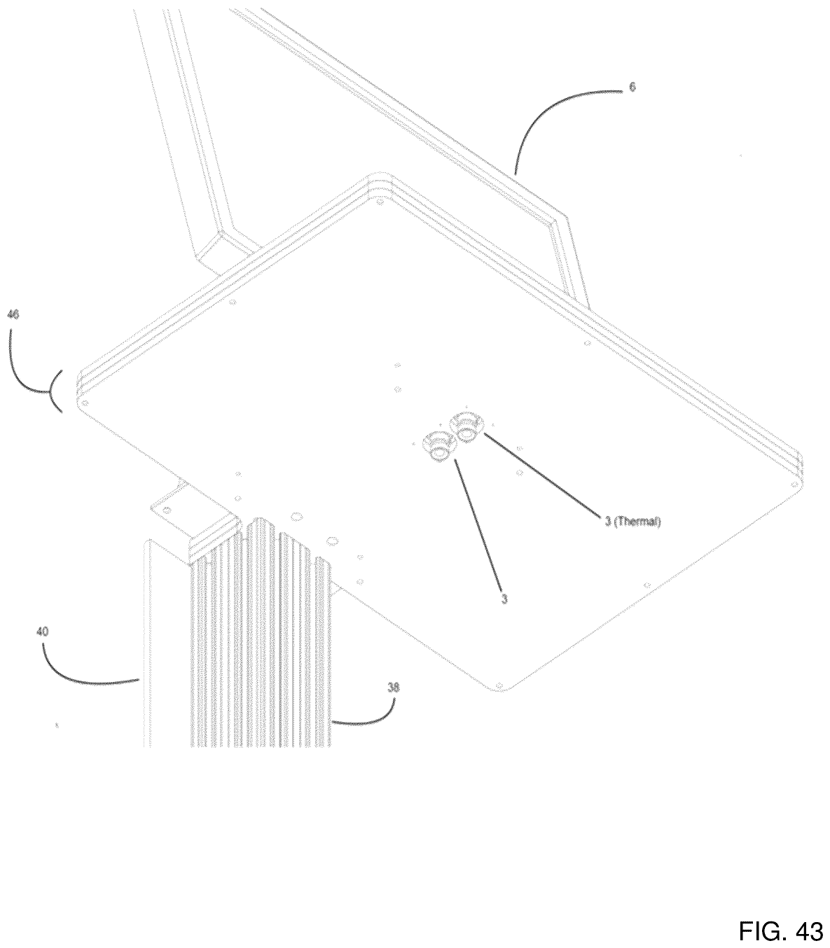

FIG. 43 depicts exemplary embodiments that include a thermal camera detector 3 (Thermal) that may be used alongside a visible light camera detector 3. The thermal camera detector 3 (Thermal) may be aligned with the visible light camera, so that the left-right positioning and angle is the same. Thus, when the visible light camera detector 3 gets the “Finished Rubbing” images of the hands, they can be more easily aligned with the images of the scanned hands from the thermal camera detector 3 (Thermal). Computer vision methods or AI models like instance/semantic segmentation or generative adversarial networks may be used to overlay the two images of the hands between the detectors 3/3 (Thermal), which may be used alongside or employ equations that convert radiometric thermal image pixels to temperature values, to generate the final feedback image showing the coverage of the cleaner/sanitizer to the user on the display 6.

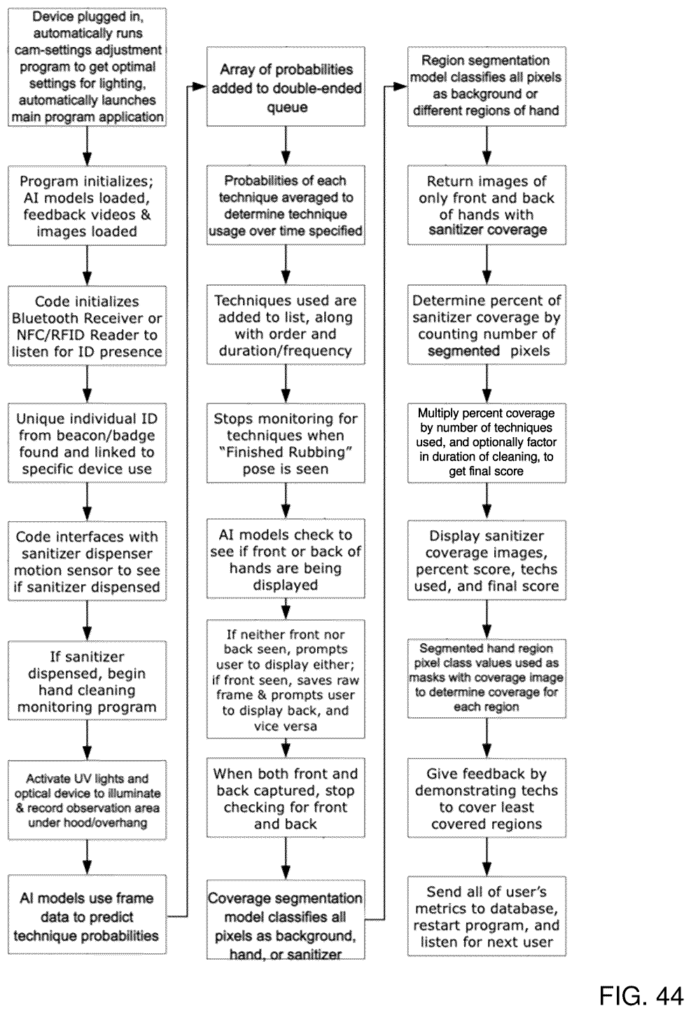

FIG. 44 provides exemplary software process flows for a portable open-space kiosk embodiment of the system, showing different models and methods that may be embodied in software 16

To start, the software 16 may activate automatically once the device is plugged in and turned on, or if the user clicks on the application, or activates it through some other manual method, including, but not limited to, entering one's name in a Graphical User Interface, clicking a button in an onscreen Graphical User Interface, pressing an external button, placing hands in the inspection area, etc. The software 16 may then run a program that adjusts the camera/detector settings. The camera settings may be set to predefined values that may or may not be adjusted. For example, the system 15 may use computer vision and AI models to analyze the lighting conditions seen by the detector 3, and generates and sets desired lighting set point values. Settings may include, but are not limited to, brightness, contrast, saturation, white balance, gain, sharpness, backlight compensation, hue, alpha, and exposure.

The process flow may then be the same or similar to that described with reference to FIG. 22, until the step after “If sanitizer dispensed, begin hand cleaning monitoring program”. At this point in process the process flow, the UV lights 2 and optical device 3 may illuminate & record the hand detection area under the hood/overhang 46.

Additionally, the technique analysis may be done in different ways than as described in FIG. 22. For example, the technique analysis may be done by using a lightweight convolutional neural network model to predict probabilities for each technique using each frame collected by the detector 3 as input. The output may be an array of the length corresponding to the total number of possible techniques, where each index in the array corresponds to each different technique. The probabilities for each may be between 0 & 1. Then, the arrays may be added to a double-ended queue, also known as a deque. This is an object that has a set length, and whenever a new item is added to the deque when it is at capacity, it removes the oldest item. The deque can be specified to a specific predefined length, or correlated to the Frames per Second to monitor over a certain length of time (e.g. you want to monitor for 2 seconds, and at an FPS of 30, that means the deque is 60 items long).

Once the deque reaches its max length, the program may then take the average of all the probabilities at each index within all the arrays in the deque. Then, the technique with the highest average probability over the duration observed may be recognized as the one that was used. In this way, video classification can be done, making sure a technique is done for a long enough time to be recognized, and the classification is smooth, and does not flicker between predicted techniques.

After the above steps are performed, the process flow may be the same as FIG. 22 until the step after “When both front and back captured, stop checking for front and back”. In chamberless embodiments, light/pixel-value thresholding may not be preferred over other methods, such as instance or semantic AI segmentation models that take images as input, and classify each pixel in the image as belonging to a certain class. Examples of such models include unet, segnet, mask r-cnn, and detectron. These models, or custom models with architecture built specifically for the purpose of use in this device, may be used as the instance or semantic segmentation models.

In various embodiments, two or more models may be employed, such as 1) a coverage model to classify all pixels in the hands-scanning image as background, hand, or sanitizer (or background, hand, or fluorescing agent/dirty areas in the case of hand-washing), 2) a region segmentation model to classify all pixels as background or the various regions of the hands (e.g. left index fingertip, right upper palm, left back of hand, etc.), and 3) a segmentation model or convolutional neural net model to determine if the hands have been cleaned at all or have any sanitizer on them, etc. These models may be trained via custom datasets for various embodiments.

In various embodiments, a coverage model may be used to generate an output that is an image array where instead of the original pixel values, each pixel index instead is assigned a number corresponding to the three classes (background, hand (uncleaned/unsanitized hand), sanitizer (cleaned/sanitized hand)), or a different model may be used to determine whether or not there is any sanitizer present, then use a model that only separates the hands from the background. The pixels assigned the background class may then be set to zero, blacking out anything that isn't hand or sanitizer, and the pixels assigned hand & sanitizer classes may then be set to any color desired to show the contrast between covered/cleaned and uncovered/uncleaned areas, such as gray hands & white sanitizer, red hands & green sanitizer, etc. These images of the hands with the background blacked out, and covered/uncovered areas of the hands may then later be shown to the user on the display 6 and stored as desired by the operator of the system 15.

Additionally, the same image used as input for the coverage model may then be used as the input for the hand region segmentation model, generating an output that is an image array where instead of the original pixel values, each pixel index instead is assigned a number corresponding to classes for non-hand (background and forearm are part of this class) and the various regions of the hands. Various models may be created to have varying degrees of granularity for the hand regions.

The process flow then may be the same as FIG. 22 until the 3rd-to-last step. The pixel classes from the hand region segmentation model may then be used as masks for the coverage image to determine the coverage of individual regions, by indexing each region with the corresponding pixel class outputs of the coverage image. The software 16 may then calculate the coverage/cleaning of each area by generating a percentage score using the total sanitized plus total unsanitized areas, for each region, excluding anything outside that specific region. At this point, the coverage percentages for each region may then be ranked, and the personalized user feedback generated, with the rest of the process flow being the same as in FIG. 22.

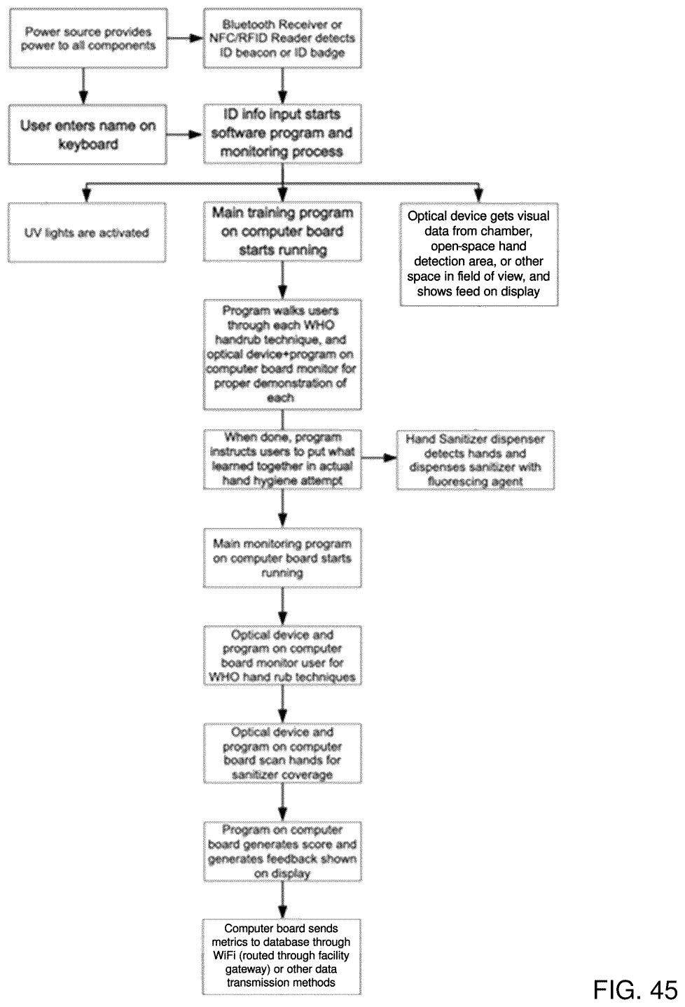

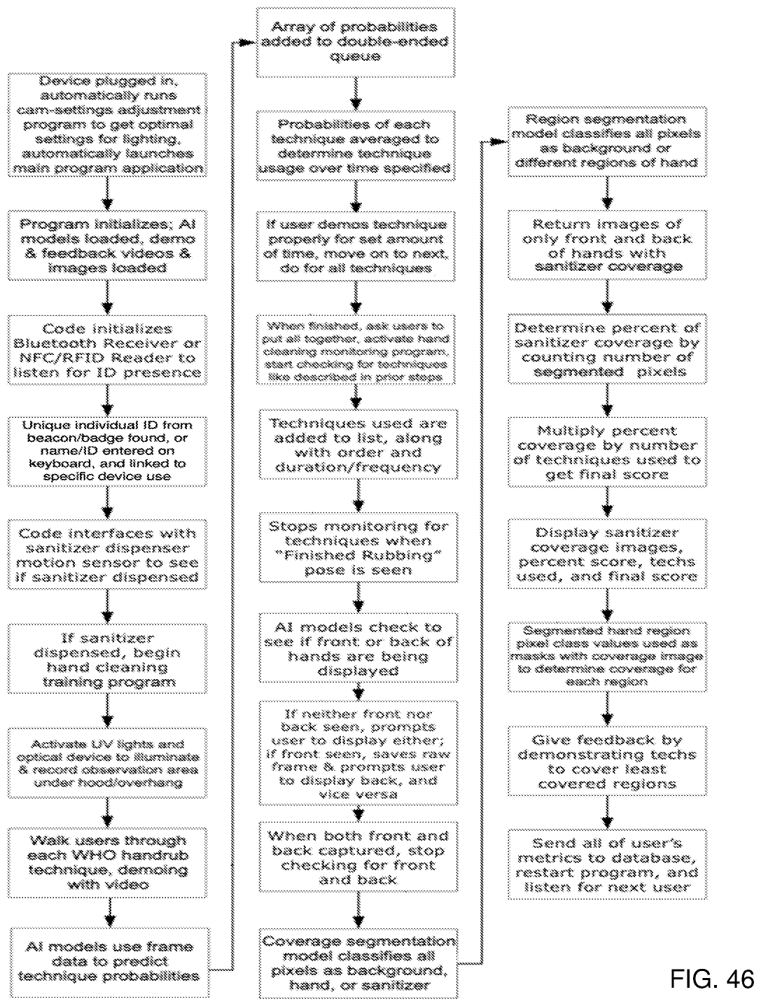

FIGS. 45-46 illustrate alternative software process flows of the system 15 when used for training automation. In most healthcare facilities, hand hygiene training is done at various times and/or for various reasons, such as onboarding requirements, regulatory requirements, certification requirements for organizations like Leapfrog, skills weeks, and intervention with employees that need to improve their hand cleaning behaviors. However, for these trainings, they often if not always have to be conducted in-person, usually by nursing leaders, infection prevention staff, or quality staff. The trainings can be very time-consuming, as a common requirement is teaching the WHO handrub techniques, then observing individuals demonstrate them in actual hand cleaning attempts, in a 1-on-1 setting for all employees. The nursing, infection prevention, education, and quality employees usually have many other pressing responsibilities that make it challenging to lead these training sessions. Thus, it is desirable to have a system which can automate this process, saving time, providing standardized evaluation & quantification of trainee hand hygiene, and further being able to track individual efficacy & progress across time.

The system 15 may be configured to have users IDs linked to each training session, and the training may walk a user through each WHO or other handrub technique, such as by showing a demonstration of the proper technique, then monitoring the users performance of the technique for compliance with the proper technique before moving onto the next technique. After completing the demonstration process, the user may be asked to attempt an actual instance of hand cleaning using the demonstrated techniques. The system 15 maythen execute the earlier described hand hygiene monitoring program to evaluate & quantify the performance of the user, and the data corresponding to completion of the training, and metrics related to performance, are generated, displayed to the user, and stored, generally in a database, for later review.

The portable open-space kiosk embodiments of the present invention may be particularly well-suited for this use-case, as trainings can take place in various parts of the facility. For instance, onboarding training may take place in an HR room, skills weeks in education centers, certification requirements training & intervention training at nursing stations. Thus, a facility may desire the capability to have the system 15 that can be maneuvered to these various locations, rather than installed at each location or take up space in hallways or require installation/infrastructure that would create friction to use.

FIG. 45 depicts exemplary component process flows that may be employed in the system 15, such as those depicted in FIGS. 36-43, and for training automation use-cases. Initially, the power source 4 may provide power to all components in the system 15. A Bluetooth 7 or NFC/RFID receiver 8 detects ID beacon or ID badge, or users enter their names/IDs manually with a keyboard or other data entry device. The linking of name/ID to session may start the software program and the software process flows depicted in FIGS. 44-46.

In training application process flows, alongside the UV lights 2 being activated, and the detector 3 collecting visual data & providing the data to the computer 5, a main training program may be started by the computer 5, which may walk users through one or more training programs, such the WHO or other handrub techniques. For example, the software may do so by displaying a demonstration of each technique on the display 6, then asking users to demonstrate proper use of each technique in view of the detectors 3/3 (Thermal), which may be referred to as a hand detection area under the hood/overhang 46. The user then does so, and the system 15 is able to track the user's progress in performing the techniques properly and providing feedback to the user. For example, measuring by time engaged in proper use (for example 5/7/X seconds of proper use), with a progress indicator, which may be a timer that changes from red to green as they progress toward the required time, a progress bar, or some other method, which may be depicted on the display 6. The software 16 may use technique recognition models to determine which techniques are being used, and if they're the proper techniques for use in the training, and if so, updates the progress indicator to show to the user they're engaging in proper technique usage.

When the user has completed a training, such as performing each of the WHO handrub techniques, the software 16 may update the user, via the display 6, and request the user to perform a hand cleaning in view of the main monitoring program, which evaluates & quantifies the performance of an actual hand hygiene attempt by the user. Then the user may get sanitizer dispensed from a hand sanitizer dispenser 9, which may or may not have a fluorescing agent, depending on whether the UV lights 2, thermal camera detector 3, or other embodiment is being used. The process from here one may then be the same as the one described for FIG. 20 from “The software may analyze . . . ” [88] on.

FIG. 46 depicts additional software process flow details that may be employed in monitoring and training automation use-cases. This process flow may be generally the same as or similar to that depicted in FIG. 44, with the addition of the training-specific steps. The first step where the system 15 powers on may be the same, but the second may be different, in that software 16 may load both the videos & images for both training & feedback. The steps are then the same until “If sanitizer dispensed, begin hand cleaning training program”. The next step is the same, but afterward, the next few steps may be different. Once the UV lights 2 are activated, and the detector 3 is detecting the hand detection area under the hood/overhang 46, the walkthrough training program may be activated & used.

First, a training program may walk users through each technique, e.g., WHO techniques, such as by displaying a video of the technique, then monitor the user's attempt at performing the technique as described in the process in FIG. 45. The models used to evaluate technique usage may be the same model used in the evaluation & quantification program, or may be individual models developed specifically to look for whether or not each individual technique is being used. The process to evaluate whether a technique is being used or not over a long enough time may use the same process described in FIG. 44 for generating probabilities of each technique possibility, then taking the highest averaged probability to be the technique being used. If the technique being looked for is used for the duration specified, the software 16 may move the user onto the next technique, doing so until each technique has been presented to the user & the user has performed the technique properly. Once the training process is complete, the user may be asked to engage in a hand cleaning attempt. For example, the user may be asked to perform one or more of the hand cleaning techniques in view of the hand cleaning monitoring program, which may be according to the process described with reference to FIG. 44. After this step, the process may be the same as described in FIG. 44 from “Techniques used are added to list, along with order and duration/frequency” on.

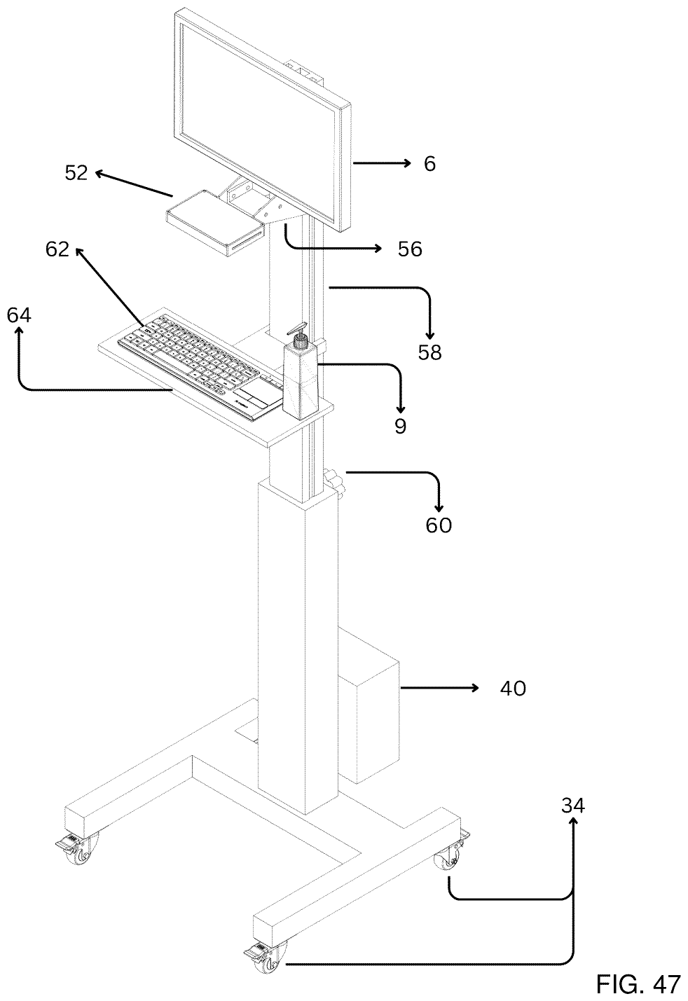

FIGS. 47-50 depicts exemplary portable open-space kiosk embodiments of the system 15 that are similar to the embodiments shown in FIGS. 36-43. The embodiments depicted by FIGS. 47-50 have a UV LED Printed Circuit Board (PCB) 54 instead of UV LED strips 2, a smaller PCB case/hood 52 instead of the large layered hood/overhang 46-50, a position-adjustable PCB case/hood attachment rig 56 that attaches the PCB case/hood 52 to the height-adjustable column 58, adjusted with the column height adjuster 60, and a position-adjustable work surface/keyboard holder 64 upon which a keyboard 62, sanitizer dispenser 9, or other materials/equipment may be placed/used.

These embodiments may provide facilities and management more flexibility in deploying the system 15 for people with a variety of sizes. For example, users may adjust the height of the column 58 and display 6, adjust the placement of the UV LED PCB 54 and its case/hood 52, and the placement of the work surface/keyboard holder 64, along the column 58 to enable optimal usage configuration.

In various embodiments, broader designs may be employed to resemble the architecture of a monitor cart/mobile PC workstation, that may be familiar to healthcare professionals, and other professionals & individuals. Thus, from hereon, these embodiments of the system 15 may be known as the height-adjustable mobile workstation embodiments.

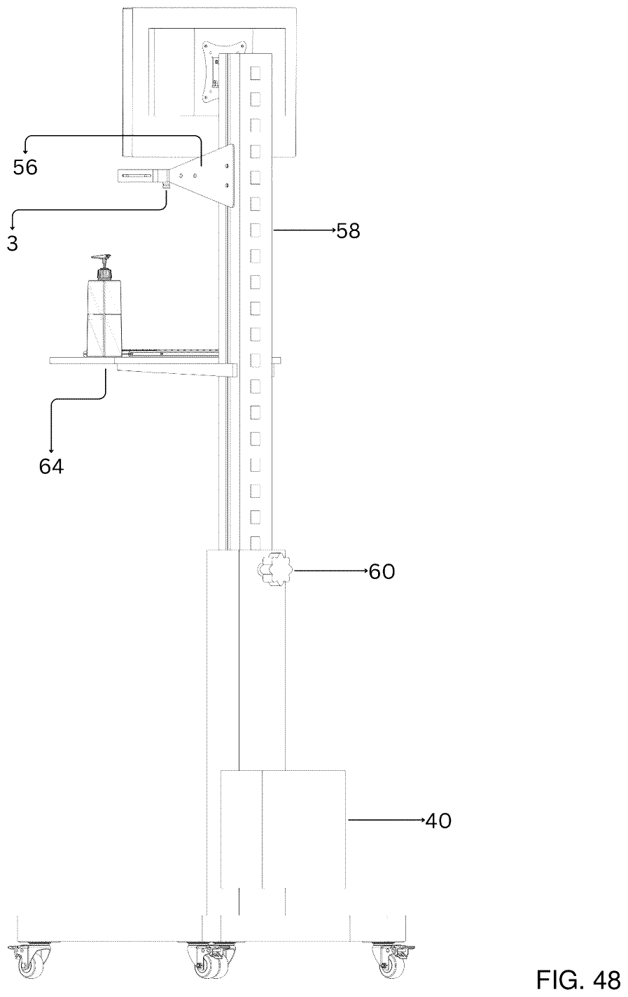

FIG. 48 shows an exemplary back right perspective view of the height-adjustable mobile workstation embodiment of the system 15 described in FIG. 47. FIG. 48 shows the back of the height-adjustable column 58, as well as a clearer view of the column height adjuster 60. In order to adjust the height of the system 15, the user may turn the column height adjuster 60 to engage or disengage the locking mechanism that may be used to pin the holes in the back of the height-adjustable column in place at the desired height. It also shows a clearer view of the hood attachment rig 56 and the work surface 64 as they may attach to the height-adjustable column 58. Also shown in full is the electronics assembly 40, shown here at the bottom of the system 15 in this embodiment. The wiring from the electronics assembly 40 to the rest of the powered components may come out of the electronics assembly 40, and may travel through a hole in the bottom of the height-adjustable column 58, and may come out through a hole near or at the top of the height-adjustable column, near the electronic components. The components inside the electronics assembly 40 in this embodiment may be similar to those described in earlier embodiments.

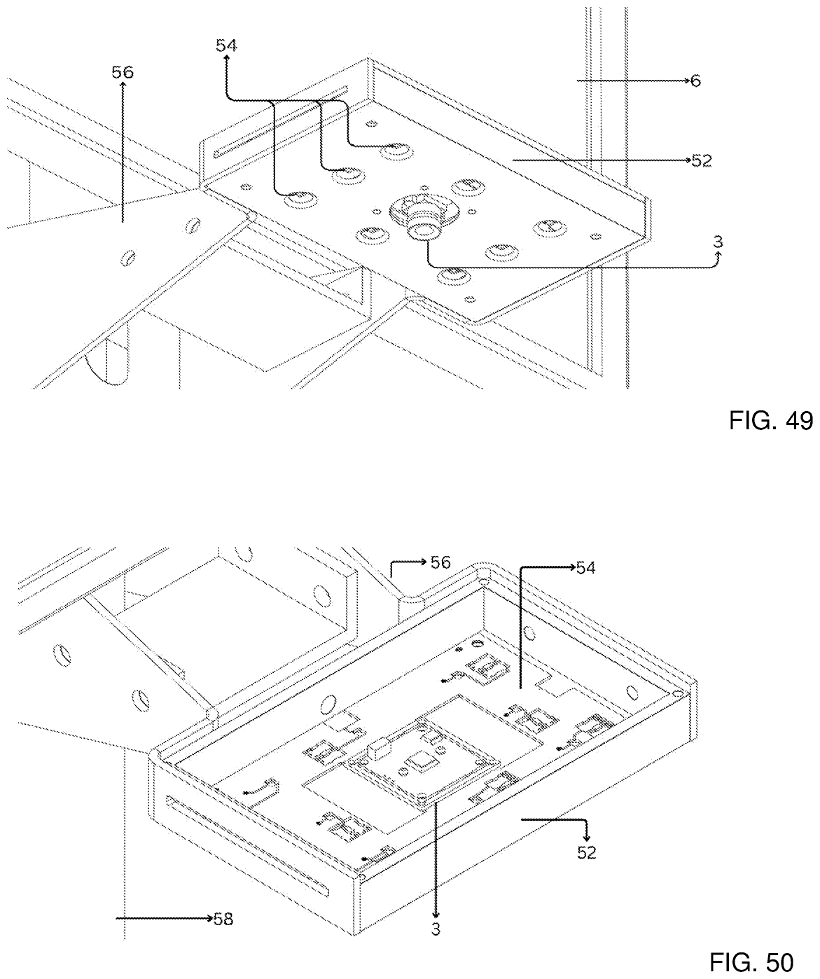

FIG. 49 depicts the underside of the PCB case/hood 52 containing the UV LED PCB 54 and optical detector 3 from a front left bottom perspective for the embodiment of the system 15 described in FIGS. 47-48. It shows the holes for the LEDs in the PCB 54, as well as the hole for the detector 3, and shows how the case/hood 52 may attach to the attachment rig 56. This view further illustrates the compact size of the PCB case/hood 52 and UV LED PCB that may be deployed in various embodiments.

FIG. 50 depicts the inside of the PCB case/hood 52 containing the UV LED PCB 54 and optical detector 3 from a front left top perspective for the embodiment of the system 15 described in FIGS. 47-49. FIG. 50 shows how the UV LED PCB 54 and optical detector 3 may be laid into and oriented within the PCB case/hood 52, showing how the UV LED PCB 54 may rest upon the bottom surface of the PCB case/hood 52, bolted into place and using the bottom surface as a heat sink, and how the optical detector 3 may be placed in the middle of the UV LED PCB 52, bolted into place to both the UV LED PCB 52 and the bottom surface of the PCB case/hood 52.

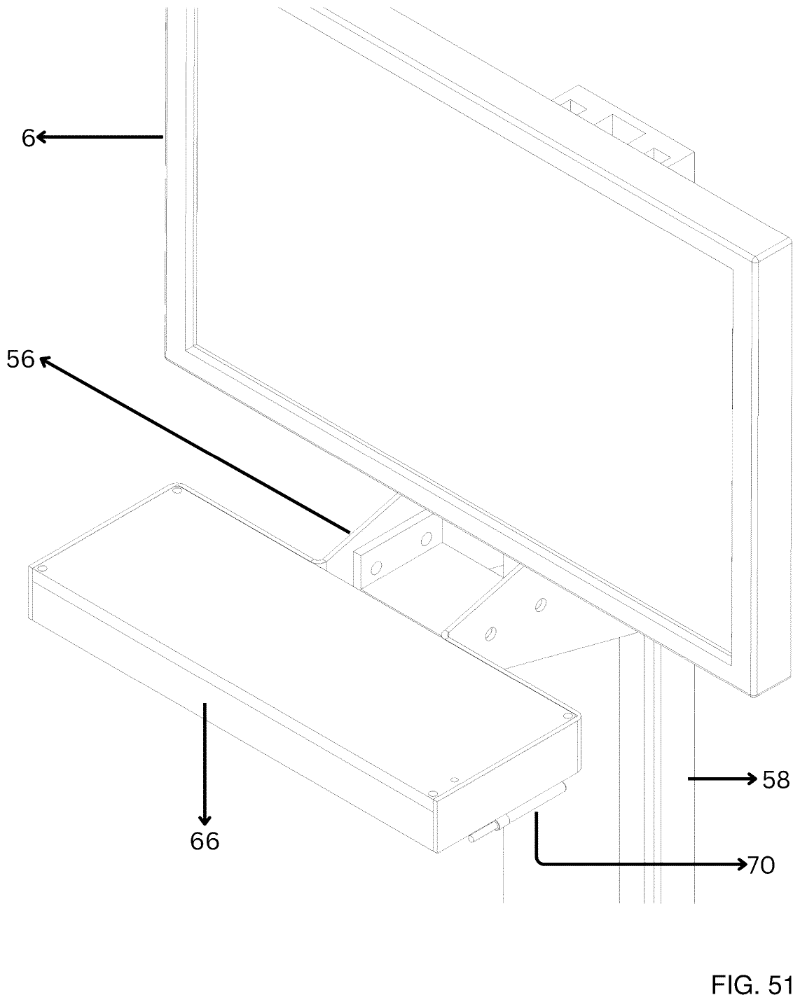

FIG. 51 depicts an exemplary front right top view of embodiments of the system 15 having the same general structure of the height-adjustable mobile workstation embodiment of the system 15 depicted in FIGS. 47-50, except that instead of a PCB case/hood 52 containing a UV LED PCB 54 that uses UV fluorescence and detection to determine sanitization, it may use a thermal detector 3 (Thermal). In place of the PCB case/hood may be a thermal case/hood 66. Additionally, there may be a new component, seen in this figure, in the temperature sensor 70, which may be used to get the ambient apparent reflective temperature of the surroundings.

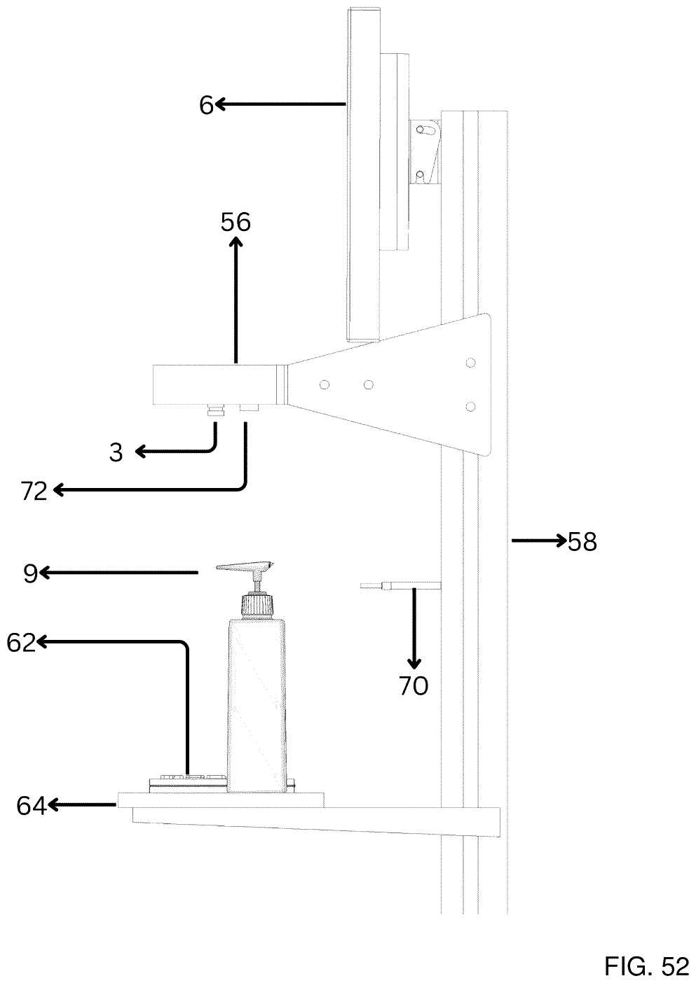

FIG. 52 depicts an exemplary right side view of the top half of the embodiment of the height-adjustable mobile workstation with thermal detectors 3 (Thermal) system 15 described in FIG. 51. FIG. 52 better shows what may be the orientation of the temperature sensor 70 on the height-adjustable column 58, which may be within the detection area under the thermal case/hood 66. It also shows another new component which may be housed within the thermal camera case/hood 66 in this embodiment of the system 15, in the ultrasonic sensor 72, which may be used to determine the distance of the hands or other objects from the detectors 3, 3 (Thermal).

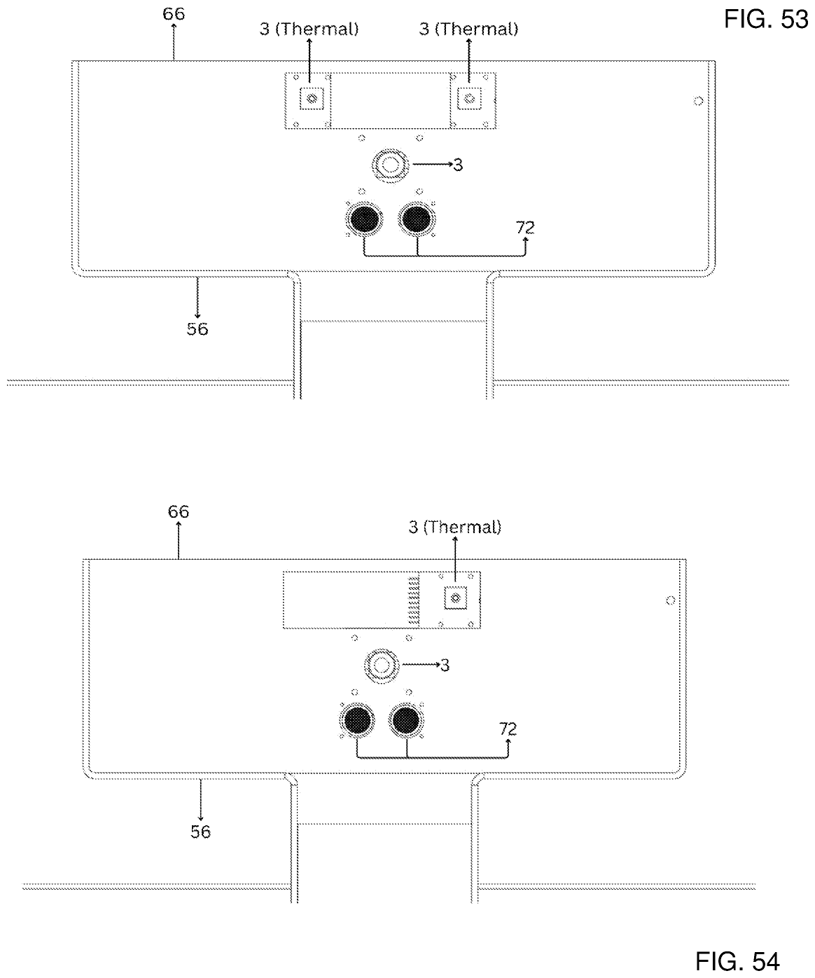

FIGS. 53-55 depict exemplary front bottom views of the embodiments of the system 15 described in FIGS. 51-52, showing the underside of the thermal case/hood 66 with two different configurations. The first configuration of the thermal camera case/hood, shown in FIG. 53, shows the use of two thermal detectors 3 (Thermal) on either side of the visible light detector 3. This may be done because small and inexpensive thermal detectors 3 (Thermal) often have very small fields of view, which may result in parts of the hands or other objects in the detection area getting cut off when images and/or video streams are captures by said thermal detectors 3 (Thermal). The two thermal detectors 3 (Thermal) may be used to generate two separate images from perspectives on opposite sides of the visible light detector 3, which may then be stitched together using computer vision techniques in order to produce one image with overlapping parts to produce a single image that has the entirety of the hands or other objects in the detection area. An object detection model may also be used to extract the left hand or other object from the left thermal detector 3 (Thermal) and the right hand or other object from the right thermal detector 3 (Thermal), then running the segmentation on those extracted hands, and laying the resulting coverage images over a new blank image array.

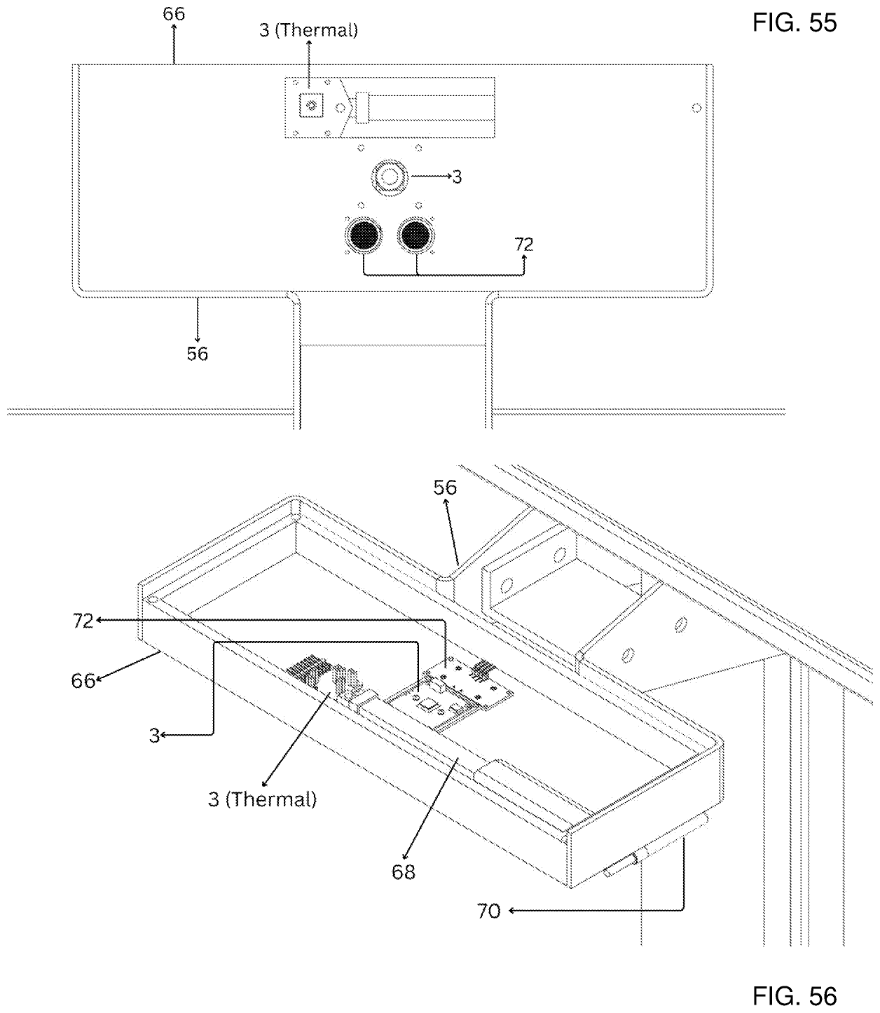

FIGS. 54-55 depict the same view described in FIG. 53, except that FIGS. 54-55 embodiments only have one thermal detector 3 (Thermal), which may be advantageous for cost, resource management, coordination, software efficiency, or other reasons. In order to achieve the same desired effect in stitching images together as described for FIG. 53 embodiment, FIGS. 54-55 embodiments may employ a thermal detector movement device 68, which may be a linear actuator or other moving device which may be used to move the thermal detector 3 (Thermal) from one location to another, in order to capture different images from different locations/perspectives, which may be used to achieve image stitching. FIG. 54 depicts an embodiment and configuration of the system 15 where the thermal detector 3 (Thermal) may be placed to the front right of the detector 3, which, after being used to take an image or video stream from that position, may be moved to a position to the front left of the detector 3 by the thermal detector movement device 68 as depicted in FIG. 55, where upon another image or stream may be taken before resetting to the original position.

FIG. 56 depicts an exemplary front right top view of the top portion of the system 15 described in FIGS. 51-55, showing the configuration of the thermal case/hood 66 that uses a thermal detector 3 (Thermal) with a thermal detector movement device 68, which may be a linear actuator or other device suitable to move the thermal detector 3 (Thermal). FIG. 56 shows the inside of the thermal case/hood 66, showing a layout/positioning for the thermal detector 3 (Thermal), the thermal detector movement device 68, and the ultrasonic sensor 72. The thermal detector movement device 68 may be attached to the front corner of the thermal case/hood 66, and may extend to move the thermal detector 3 (Thermal) across the front of the detector 3, which may be proximate to the ultrasonic sensor 72. The thermal detector movement device 68 is shown in the extended position. In other embodiments or configurations, the thermal detector movement device 68 may be positioned elsewhere, and another type of device may be used to translate the thermal detector 3 (Thermal). Additional ultrasonic sensors 72 may be used, and/or positioned elsewhere.

In various embodiments of the system 15, radiometric thermal detectors 3 (Thermal) may be used to capture thermal images of hands or other objects. A benefit of radiometric thermal detectors 3 (Thermal) is the ability to capture data from images in such a way where the raw pixel values of the images they capture may be converted into temperature values for each pixel. Various processes may be used to accomplish the conversion. For example, a process that may do this may first involve scaling the pixels by the maximum value of the raw image format, which may be 16-bit, 14-bit, or other formats, depending on the type of thermal detector 3 (Thermal). The scaled values may then be rescaled and adjusted to be within the temperature range of the thermal detector 3 (Thermal). The scaled and rescaled/adjusted pixel values may be further adjusted to account for emissivity, which is a measure of a material's ability to emit thermal radiation compared to a perfect blackbody (for example, the emissivity of human skin is about 0.98), reflected apparent temperature (which may be negligible for objects with high emissivity), and distance, which is measured by the ultrasonic sensor 72. In some applications, the adjustment may not be necessary, however, and a simple equation that scales the pixels by the max value, then applies a scaling factor and converts from Kelvin to Celsius may be sufficiently accurate. Other equations may be used as well, depending on environment and use case.

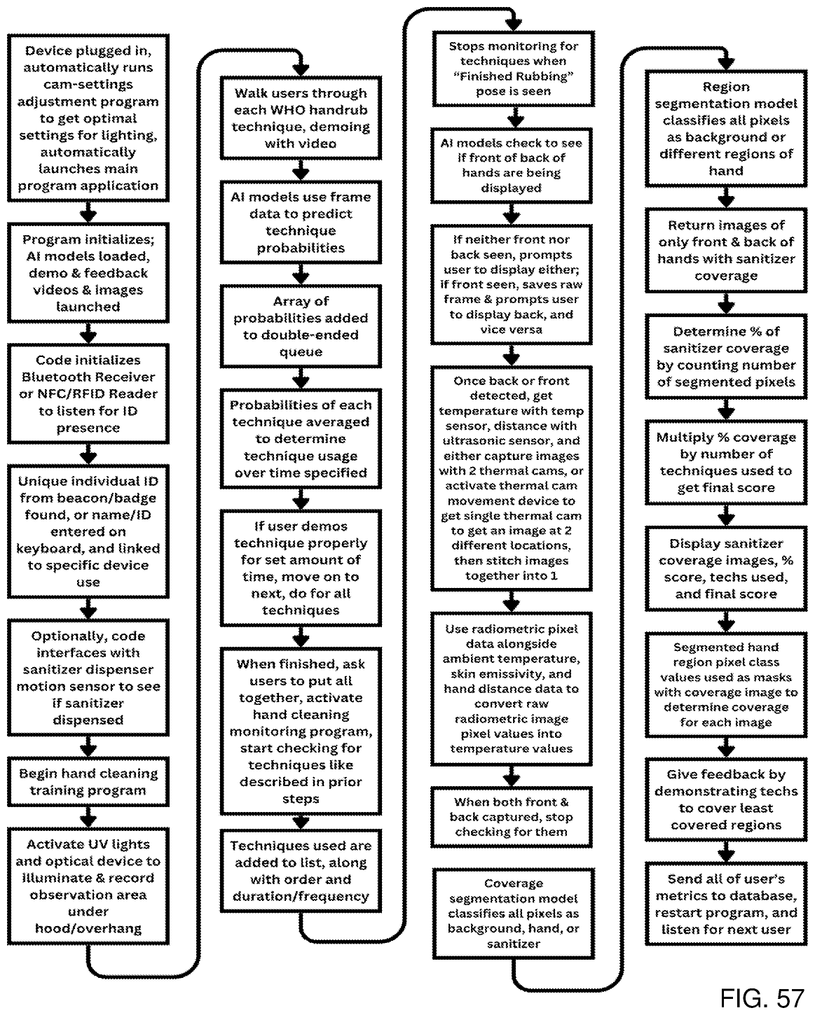

FIG. 57 depicts exemplary software process flows for the height-adjustable mobile workstation embodiments of the device with thermal detectors 3 (Thermal) in FIGS. 51-56. The process may be generally the same as that in FIG. 46 until the step after “If neither front nor back seen . . . ”. After this step, the next step may instead be to obtain the ambient temperature of the surroundings with the temperature sensor 70, distance with the ultrasonic sensor 72, and capture the images with the thermal detector(s) 3 (Thermal). In the case that there are two thermal detectors 3 (Thermal) used, the software may capture images from both thermal detectors 3 (Thermal), then stitch the two together, or extract the hands from each image then add those to a blank image array. In the case that there is one thermal detector 3 (Thermal) and a thermal detector movement device 68, the software may then take one image using the thermal detector 3 (Thermal) at the first location, then send a signal to the thermal detector movement device 68 to move the thermal detector 3 (Thermal) to additional locations, then capture an image at the additional locations. Then the process may be the same for stitching and/or extracting hands from the images. The next step may then be converting the images to temperature values using exemplary processes like those described in the preceding paragraph, or any other equations or processes that may apply, and using the temperature data for each pixel in an array to serve as the source data for the segmentation models in the following steps.

As used herein, the term component is intended to be broadly construed as hardware, firmware, and/or a combination of hardware and software. It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

The foregoing disclosure provides examples, illustrations and descriptions of the present invention, but is not intended to be exhaustive or to limit the implementations to the precise form disclosed. Modifications and variations are possible in light of the above disclosure or may be acquired from practice of the implementations. These and other variations and modifications of the present invention are possible and contemplated, and it is intended that the foregoing specification and the following claims cover such modifications and variations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A hand sanitization monitoring system comprising:
a detector positioned to detect and provide images of the hand detection area;
at least one processor and memory, the processor to
receive the images from the detector,
determine areas of the image corresponding to sanitized areas of the hands from unsanitized areas of the hands,
calculate a score using at least a percentage of the sanitized areas to a total area corresponding to the sanitized area plus the unsanitized area, and
provide at least the score; and
a display positioned proximate the hand detection area to display at least the score provided by the processor.

2. The system of claim 1, further comprising
at least one illumination device providing at least one UV light and visible light; and
the detector is a camera capturing visual images of the hands, where the sanitized and unsanitized areas of the hands are determined based on a determination of the presence or absence of at least one of hand sanitizer and germ proxy agent on areas of the hands in the images.

3. The system of claim 2, where
the processor assesses visible lighting in the hand detection area and adjusts the illumination of the hand detection area by adjusting the at least one illumination device.

4. The system of claim 1, where
the detector is a thermal imaging camera capturing thermal images of the hands.

5. The system of claim 1, where
the processor is further to
determine at least one of hand rubbing techniques and a duration of hand rubbing from the images; and
calculate the score using at least one of the detected hand rubbing techniques and the duration of hand rubbing.

6. The system of claim 1, where
the at least one illumination device, detector, processor, and display are provided in portable kiosk that is one of height-adjustable and non-height-adjustable.

7. The system of claim 1, where
the at least one illumination device and detector are mounted to a bottom surface of a hood and the display is provided above the hood.

8. A method of performing hand sanitization monitoring comprising:
providing a detector positioned to detect and provide images of hands within the hand detection area;
instructing a user to dispense at least one of a hand sanitizer and a germ-proxy agent onto their hands and place their hands in the hand detection area;
detecting, via the detector, images of hands within the hand detection area and providing images of the hands by the detector;
receiving, by a processor, the images from the detector;
determining, by the processor, areas of the image corresponding to sanitized areas of the hands from unsanitized areas of the hands based on determining the presence or absence of at least one of the hand sanitizer and a germ-proxy agent on the hands in the image,
calculating, by the processor, a score using at least a percentage of sanitized areas to the total area corresponding to the sanitized and unsanitized areas, and
providing, by the processor, at least the score to at least a display; and
displaying, by the display, at least the score.

9. The method of claim 8, further comprising:
instructing the user to perform at least one hand rubbing technique in the hand detection area;
detecting the at least one hand rubbing technique and a duration of the performance of the at least one hand rubbing technique from the images; and
calculating the score using at least one of the detected hand rubbing techniques and the duration of performance of the hand rubbing technique.

10. The method of claim 9, further comprising:
identifying a user based on information from at least one an identification device, information input into the display, and an identifier received via a wireless signal;
storing at least one of the score, the percentage of sanitized area, the detected hand rubbing techniques, and the duration of hand rubbing; and
providing at least one of the score, the percentage of sanitized area, the detected hand rubbing techniques, and the duration of hand rubbing to the display for viewing.

11. The method of claim 10, where
comparing information include at least one of the score, percentage of sanitized area, detected hand rubbing techniques, and duration of hand rubbing of the user with the information of groups of user including at least one other user; and
providing the comparison of information to the display for viewing.

12. The method of claim 8, wherein
the detector is at least one of a thermal detector and a UV detector, the UV detector detecting fluorescence of the hand sanitizer and germ-proxy agent.

13. The method of claim 8, where
requesting, via the display, the user to
further sanitize their hands when the score does not exceed a threshold score; and
place their hands in the hand detection area to be detected following further sanitization.

14. The method of claim 8, where
calculating the score is performed by counting pixels in the image corresponding to sanitized areas and unsanitized areas.

15. The method of claim 8, further comprising
displaying, via the display, to a user a demonstration of at least one hand sanitizing technique;
requesting, via the display, the user to perform the at least one hand sanitizing technique in the hand detection area; and
providing feedback, via the display, to the user on the user's performance of the at least one hand sanitizing technique.

16. The method of claim 8, where
determining is performed by the processor using a coverage segmentation model to classify all pixels in the hands-scanning image as background, hand, or sanitizer, and a region segmentation model to classify all pixels as background or the various regions of the hands.

17. The method of claim 16, where
the coverage model assigns a pixel index to each pixel corresponding to one of background, hand, and sanitizer.

18. The method of claim 16, where
pixels assigned a pixel index corresponding to background are not displayed.

19. A sanitization monitoring system comprising:
a detector to provide at least one image of an object within its detection range; and
at least one processor, the processor to
receive the at least one image from the detector,
determine areas of the image corresponding to sanitized areas of the object from unsanitized areas of the object,
calculate a percentage of sanitized areas to the total area corresponding to the sanitized and unsanitized areas, and
report at least the percentage of sanitized area.

20. The system of claim 19, where
the object is at least one human hand; and
the detector is at least one of a thermal imaging camera positioned to detect temperature differences on the at least one human hand resulting from at least one of hand sanitizer and germ-proxy agent contacting the hands and a UV detector detecting fluorescence of the hand sanitizer and germ-proxy agent.
